(19) United States
(12) Patent Application Publication
(10) Pub. No.: US 2014/0149242 A1
(43) Pub. Date: May 29, 2014

(54) MODULAR MERCHANDISER SYSTEM AND METHOD OF PROVIDING THE SAME

(71) Applicants: Harold L. Turner, JR., Signal Mountain, TN (US); Joseph Theodore Bauer, Saint Paul, MN (US); Gabriel Garduno, Minneapolis, MN (US); Matthew Douglas Reier, Saint Paul, MN (US); Louis Frederick Polk, Excelsior, MN (US); Kenneth Earl Ramsey, Eagan, MN (US); Charles M. Gruber, Saint Paul, MN (US); Howard Lynn Hammond, Ooltewah, TN (US); Michael Shaver, Ringgold, GA (US); Michael Piontek, Chicago, IL (US)

(72) Inventors: Harold L. Turner, JR., Signal Mountain, TN (US); Joseph Theodore Bauer, Saint Paul, MN (US); Gabriel Garduno, Minneapolis, MN (US); Matthew Douglas Reier, Saint Paul, MN (US); Louis Frederick Polk, Excelsior, MN (US); Kenneth Earl Ramsey, Eagan, MN (US); Charles M. Gruber, Saint Paul, MN (US); Howard Lynn Hammond, Ooltewah, TN (US); Michael Shaver, Ringgold, GA (US); Michael Piontek, Chicago, IL (US)

(21) Appl. No.: 13/575,633

(22) PCT Filed: Jan. 29, 2011
(86) PCT No.: PCT/US11/00157

§ 371 Date: Sep. 4, 2013

Related U.S. Application Data
(60) Provisional application No. 61/337,039, filed on Jan. 29, 2010.
(60) Provisional application No. 61/397,746, filed on Jun. 16, 2010.

(51) Int. Cl. A47F 5/00; G06Q 30/00

(52) U.S. Cl. CPC A47F 5/0018; G06Q 30/00
USPC 705/26.1; 211/189; 211/186; 29/525.01

(57) ABSTRACT

A modular merchandiser and system with a frame of vertical posts and horizontal bars is carried on legs and carries grid elements sandwiching an indicia panel. Adjacent merchandiser panels can be linearly, perpendicularly or angularly (from about 10° to 350°) joined, and placed on the front end or other positions in various locations to carry various product on novel, height adjustable accessories and merchandising effects. Various parts of the merchandiser and the accessories therefor may be obtained in a first financial transaction (lease or sale) and others in subsequent financial transactions to update the same. Supporting special software can be similarly obtained and used to achieve uniform displays by using the included indicia panel. The system permits easier, less expensive, less wasteful, faster, and more environmentally friendly updating of the merchandiser, accessories, frame and grid portions separately.

An improved hinge coupler is also provided for joining two panels together, one of a male projection and complimentary female socket is provided on each of the panels, and a connecting hinge link is provided having the other of a male projection and complimentary female socket is provided at the ends of the coupler link to hold the hinge coupler and the two panels in the desired angular position. The angular portion of the panels can be determined and changed by the relative position of the male projections in the receptive complimentary shaped female sockets.

### DISCLOSURE

This application is a United States Patent Cooperation Treaty (PCT) Application, and claims the benefit and priority and filing dates of U.S. Provisional Patent Application Ser. No. 61/337,039, filed Jan. 29, 2010, entitled “Modular Merchandiser and Method of Providing the Same” in the names of the inventors Harold L. Turner, Jr., Joseph Theodore Bauer, Gabriel Garduno, Matthew Douglas Reier, Louis Frederick Polk, and Kenneth Earl Ramsey (Note: Charles M. Gruber one of the inventor's hereof named was inadvertently omitted) and U.S. Provisional Application Ser. No. 61/397,746, filed Jun. 16, 2010, entitled “Panel Coupler Hinge,” in the names of the inventors Kenny Ramsey, Charles M. Gruber, Harold Lloyd Turner, Jr., Howard Lynn Hammond, Michael Lynn Shaver, and Michael Piontek. Said above two Provisional Applications are herein incorporated by reference. This invention relates to consumer retail fixtures known as merchandisers, and particularly to modular merchandisers which can be offered in a first financial transaction and components thereof or other accessories therefore, offered in the same or subsequent financial transactions, and has panels and various accessories and parts therefore and an improved coupler hinge which can connect two adjacent panels or grids.

### BACKGROUND OF THE INVENTION

It is known to use merchandisers or product display units in various forms, such as two pegboard type panels set to form a “T” which can be placed at an aisle end, in for example, a retail store. One form of merchandisers is a front end merchandiser which is usually located at a check-out or check-in location for a retail store and other locations where consumers purchase or pay for goods or services and are offered the opportunity to purchase additional products or services displayed on the front end merchandisers.

Heretofore, prior art merchandisers, and particularly front end merchandisers, were offered and sold as complete units. These prior complete merchandisers included the supporting structure and product displays and were installed and used until management of the location decides to replace the merchandiser and its product displays. As this prior merchandiser, including its base structure and product display components are fixed, they offer limited flexibility to change the nature or mix of goods or products offered on the merchandisers. Many times due to the high cost and expense of replacing an entire prior art merchandiser, they were used longer than they should be, and they can become somewhat run down and dated. The higher costs in replacing prior art merchandisers were due to the need to rip out the entire old merchandiser, and manufacture, ship in, and install an entire new merchandiser. The prior art merchandiser was not an environmentally friendly fixture since it had to be disposed of, usually by “junking,” at the end of life.

Where a plurality of outlets (chain stores) might have similar or identical prior art merchandisers, even though some effort was made to make their displays uniform, such was difficult to achieve due to the lack of central control on what was done in each location. For example, while a pegboard type display might be used, though the pegboard accessories were identical, they were not uniformly placed in or on each of the displays, so that the uniformity desired was not achieved.

One such prior art merchandiser is sold by DCI of Milwaukee, Wis. Some of these merchandisers have panels or sections framed by tubular members, both horizontal and vertical. These panels can be placed adjacent one another to form complimentary panels. These panels may be held upright on legs and joined to each other.

### SUMMARY OF THE INVENTION

The present invention includes a business method and system, novel and unique apparatus in the form of a merchandiser with a modular frame or base to form a panel, for carrying a plurality of product display components on the same, particularly in a uniform manner, and including software and methods for carrying out the same.

The frame/base and its product display components or accessories form the front end and other portions of a merchandiser system.

The business method provides for conducting a first business transaction giving the merchant/purchaser possession of a front-end merchandiser frame core/base, which optionally could also include one or more product display components. Possession of the first or additional product display components for engagement with the front end or other merchandiser frame core/base, can be offered and/or granted in a second or subsequent financial transactions.

The first financial transaction can be an outright sale, financed, or, alternatively a lease, for an extended period of time, such as 5 to 7 years, may or may not include the sale or lease of certain type product display components or accessories for use on the novel front end or other merchandiser frame core/base and in the system. The initial type product display components or accessories and/or additional product type display accessories which can be used on the frame core/base can be offered for sale or lease in a second and/or subsequent financial transaction. The various product display components obtained and/or interchanged can be used on the frame core/base system. Thus, the merchant or other user of the front end merchandiser can obtain a front end or other merchandiser frame or base in one financial transaction, and in the same or subsequent financial transaction or transactions obtain the desired product display modules which fit on the previously obtained frame or base. Thus, when it is desired to update the other or front end merchandiser and/or change the product mix, one need not replace an entire merchandiser, but one can simply buy or lease the desired new or different type panels and product display modules and place them on the existing base or frame. Thus an updating or remodeling can be more easily done, without: the need to tear out the entire old unit, disrupting the location during the rip out and new install, and the disadvantages of higher cost and longer time needed to complete an entire new installation.

As noted, the other or front end merchandiser of the present invention comprises a frame core/base system, wherein the frame core/base system and various product display components are available and separately priced. The component may be selected from an inventory of various product display components each having a frame core/base attachment interface engageable with any of the frame core/base in the system.

Typical places where such modular front end or other merchandisers could be used would be check out counters or merchandisers in other areas not associated with check-out, for grocery and retail stores, movie theaters, businesses, buildings, ball parks, museums, bus or train stations and airport check-in check-out, and confection counters. This list of locations is just by way of examples and not limitation, as other locations where potential consumers/customers are present, could be utilized. The merchandiser could be located at, adjacent, before or after the cashier's or self checkout position, along aisles, or at aisle ends.

The frame or base elements of accessories or modules for the merchandiser are both formed to complementary interfit with each other and are of consistent construction so other merchandiser frames or accessories or modules can be made and/or obtained at any time and any will interfit with earlier made or obtained complementary elements. Frame core/bases and product display components can be designed, manufactured and validated independently (to interfit) each other in accordance with a standardized interface system. The interface, removable but lockable and adjustably attached components may comprise, but are not limited to, as for example, a male connector or set of male connectors on the product display component(s) that interface and interfit with matching female connector(s) on the frame core/base structure. The interfit not only connects but also supports the component on the frame/base or panel.

The frame core/base presents fewer or no restrictions on product display component placement, thereby accelerating the development process for new or subsequent product display components and increasing the flexibility of display component configurations. As new or future product display components are designed to mate with the previously manufactured, validated and installed frame core/base, at any future time newly designed product display components may be more quickly developed in response to market demands. For example, such could include a new product holder developed to draw unique, special attention to a new product, and attached in a wide range of configurations and locations to the previously (or in the future) manufactured, validated and installed frame core/base system. Should the merchant desire to change the product mix such is easily accomplished, as all product display modules are made with the uniform interface to fit the frame or base, and can simply be obtained in an additional financial transaction (purchased or leased), and then installed either temporarily or permanently.

The front end or other merchandiser not only capitalizes upon the interchangeability of merchandising components on the frame core/base, but also on the expandability, and/or changeability of the frame/base core. The present invention has the ability to change the frame core/base system by adding or deleting portions thereof is furthered by a unique frame or panel interlock system. The base may comprise connectable metal frames, such as integral frame/grill—one or two of latter, which can be made integral as by welding, onto which the modules fit, and can be self supporting and have indicia means by which the product display modules can be uniformly and exactly attached, added or deleted.

The frames are indexable or can carry indicia (such as indicia, when in pegboard or other form could indicate columns and rows or outlines of product display devices and the specification of the same. This index feature enables a corporate planning department to more easily plan a uniform display for all its locations or outlets. Thus the locations or outlets can more easily follow and carry out the corporate instructions, easily conform their displays to the corporate plan, and achieve desired display uniformity.

Further to assist in the planning, the frame members and modular product displays can be incorporated into a spatial software planning program which presents the frame, core/bases, and all the modular displays in all possible or accomplishable arrangements. The software can print out the index or a flexible sheet and may be in the form of indicia, columns and rows, or product carrying devices outlines and indentifying specifications. This software can be acquired in any of the above or subsequent, separate financial transaction or offered as a service to the customer. The software can generate a plan for the desired display which can be fitted onto a module or panel and then used to arrange the display. This plan sheet can be shipped to the various locations, and after the display is set up, the plan sheet removed.

The interchangeable product display components enables substantial freedom and variation in the types, sizes, shapes and quantities of consumer products displayed such as, by way of example, candies, gums, convenience items, magazines, books, newspapers, brochures, pamphlets, maps, beverages, general merchandise, etc. that can be interchanged on a frame core/base system in a free unrestrained or non-compartmentalized manner. The accessories or modules for displaying products could, for example, and not as a limitation, include solid and wire shelves, solid and wire baskets, flat or inclined shelves and baskets, single item display hooks or other merchandising displays such as brochure, pamphlet, map, magazine, newspaper and book racks, wire, metal or plastic pockets, pegs, hangers, hooks, custom product holders, including, unique custom product holders, shelf edge or other product spot lighting, LED, shelf edge lighting or other video displays with or without sound, digital signage, connected through an optional add-on low voltage power supply system. These and other future technology enhancements may be provided on the front end or other merchandiser of the present invention.

Thus, various display arrangements may be easily provided as well as enhanced space utilization, and different types of design themes, aesthetics and functionality, easily achieved with the modular merchandiser, business method, system, and methods of the present invention.

Various grid structure and hinge coupler are shown and disclosed herein and in the above mentioned U.S. Provisional Patent Applications. Further, improved forms of hinge coupler are herein shown and disclosed, and is to some degree similar to, but in other aspects different from, those shown in the above U.S. Provisional Patent Applications. The hinge coupler of the present invention comprises a retaining means for retaining the coupler in two of the adjacent vertical frame members of the two panels or grids to be joined. The retaining means can comprise for example an interference fit, bolts or fasteners, threading, adhesive, welding, brazing, pin means, or even the heretofore disclosed wedge means for retaining a retaining body in the interior of the vertical member. The pin means can be in the form of a cross pin that engages both the tube and retaining body. The retaining body can be in the form of an insert inserted into the hollow of the vertical member, such as formed by a round or square tube. This body could even be at least partially, if not fully, formed in the tube itself. As noted, the retaining means can be either a heretofore disclosed wedge (nut drawn tight to spread into the retaining body to frictionally, tightly fit it into the tube in which this retaining body is to be retained), such as disclosed herein or in the prior Provisional Applications. The retaining means can be alternatively, a cross pin, placed, driven or held by interference fit into complimenting holes or openings formed in both the vertical tube or member and the retaining body. The cross pin can have a threaded opening to receive a fastener to hold it and the tube and rest of the hinge coupler in place.

The pin and retaining body and its cooperating openings can be indexed to keep the thread opening properly aligned when the fastener is not in place. Also, the engaging end of the fastener can be pointed to facilitate it entering the cooperating threaded opening. The pin and its cooperating opening may be non-circular, say square, to hold its threaded opening in position to receive its respective fastener.

The other or outer end of the retaining body or insert comprises fastening means for retaining the coupling or hinging means extending between and holding together the two adjacent panels or screens. The fastening means can be in the form of a screw or bolt and a cooperating threaded opening. While the screw or bolt could be on the retaining body, preferably it is the threaded opening that is on the retaining body. The retaining body and coupling link on each end has one of cooperating male projection means and female socket means thereon. Thus, the coupling means would have one or the other at each of its ends and would cooperate with the two retaining bodies, insert or integral, having the cooperating socket means or projection means therein to hold the panels or grids to each other in a desired relationship.

Preferably each of the retaining bodies has the female socket means and the coupling means or links has two separate retaining male projections, one at each end. Alternatively, a reverse construction could also be utilized with the socket on the link and projection on the tube. To provide for multiple placement of the panels or screens at various angles, the male projections means and female socket means can have numerous, equally spaced (similar to for example a hex head bolt and socket common in tools, or 20 point bolt and socket less common in tools) or unequally spaced, points. Thus, by relatively rotating the male projection in a cooperating socket, the hinge can be placed in various angular positions to cause the adjacent panels or screens, when assembled with the coupler hinge of the present invention, to be placed at and held in various angular positions to one another. Now as mentioned, if desired, the points need not be equally spaced but could be differently spaced so that different relative placements of panels into sockets could give different steps of angular displacement. However, the equally spaced male and female points (socket) panels may be more easily and less expensively manufactured and used.

Now the male projection can have fewer equally spaced than the socket. For example, one could have a male portion with four points spaced 90 degrees apart, and such could be used with socket portions of 4, 8, 12, 20, 24, etc . . . receptive female points, and the greater number thus giving finer and finer steps of angular adjustment.

For example, one could use 4 male points equally spaced at 90 degrees, and socket portions with 20 points spaced at 18 degrees apart. Such a construction would give a hinge capable of adjusting two adjacent screens from about 18 degrees, to 90 degrees (perpendicular), to 180 degrees (linear) to 342 degrees, or anywhere in between in steps of 18 degrees. For example, and preferably, if there were four, 90 degrees spaced apart male points and 16 female (socket) points, the angular positions for the screens or panels would be on 22.5 degrees steps. Now while not in a coupling use, the link can be put in a stored position so that it aligns below its respective panel.

The vertical tube, retainer body, and hinge coupler element can be held assembled by outer fastener means, such as a threaded (insert) body fitting into a threaded opening. Preferably, the threaded opening is formed on, in or in conjunction with, the retainer body, and the threaded screw is provided to extend into the center of the female socket of the retainer body. Preferably, the outer end of the screw has a head, or more preferably a manually turnable knob or handle, so no tools are needed to install or remove the fastener or for assembly. Further, as mentioned, the socket itself could be integrally or directly formed as by punching or swaging in a die in the end of the vertical tube of the frame of the panel. This forming or punching step could be done before or after the tube is secured or welded together to form the panel frame.

To assemble the hinge coupler, the retainer bodies or inserts (or integrally formed) are slipped into (or formed in) the two vertical tubes at their two tops, or even two bottoms. The hinge coupler of the present invention is capable of being used at top, and optionally at the bottom ends, of the vertical tubes to hold two adjacent screens or panels or grids together. If the panels are to be sufficiently angularly placed, say greater than 45 degrees, or perpendicular rather than linear (in line), the panels would be self-supporting without other legs. If panels are to be linear or in line, or less angularly placed, then supporting legs are needed. The two cross or retaining pins for the coupler, which may be made of metal or plastic, are placed or driven in to the opening in the tubes and retaining bodies or inserts. The cross pins can be sized to provide a free fit or an interference fit. In the former, some type of indexing may be provided, while in the latter, the interfaces fit will hold position to receive the fasteners. The panels with their tubes are positioned as desired and the male projections of the coupling portion fitted over socket portions to provide the selected and desired angle. Then the retaining fasteners are put through the male portions and center openings in the female portions and then screwed into threaded opening at the end to hold the two panels at the selected one of the various angular steps available.

As noted, the socket can be formed by punching or broaching. The male projections can be integrally formed, machined or cast or even welded onto the link. Of course, the reverse construction could be similarly formed.

The parts may be made of steel, stainless steel, aluminum, other metals or plastics and/or a combination of these materials.

The system includes single legs for the ends of the panels, double legs for joined or adjacent panels. The legs can be adjusted to carry the panel at various positions. Special end and “T” panels can be provided, which can be joined at or near its center or biased toward one end. Sets of product hooks of similar construction but of various vertical drops can be provided to accommodate each product, for example, the total vertical drop for a set could be 1 or 2 inches with a vertical drop in steps of, say from ⅛ to ¼ inch or other drops and steps as desired or needed. The system includes dividers hung from panels, fixed or adjustable leg bumper rails fitted between legs. All these components can be arranged in various manners to achieve the display desired. Additionally separate units such as coolers, refrigerators or freezers may be incorporated into the system and/or surrounded by complementary panels.

### BRIEF DESCRIPTION OF THE DRAWINGS

FIG. 1 is a perspective view of a first embodiment of merchandiser particularly for the front end, shown with accessories or product display modules of the present invention.

FIG. 2 is a perspective view second embodiment frame of a front end merchandiser shown of the present invention.

FIG. 3 is a perspective view of the frame of FIG. 2 fitted with product display accessories or modules for use therewith and shown at a check out station.

FIG. 4 is a flow diagram showing the business method of the present invention and of acquiring a frame and panel and optionally some of the accessories of the present invention in a first financial transaction and acquiring additional accessories in a second, and subsequent financial transactions.

FIG. 5 is a schematic listing different accessories may be interfaced with the merchandiser panel of the present invention.

FIG. 6 shows a typical panel which could vary in width, say, from as narrow as 18 to 24 inches to as wide as 48 or more inches and vary in height, say, of 54 to 63 inches, with a pair of legs to vertically support the panel.

FIG. 7 shows an enlarged portion of a typical grid for a panel which could having spacing 2 inches for horizontal members and 6 or 8 inches for vertical members.

FIG. 8 shows a further enlargement and middle printed panel carrying placement indicia which could be sandwiched between the grids of the panels shown in FIG. 6 and FIG. 7.

FIG. 9 illustrates in more detail the indicia of the middle panel shown in FIG. 8, with, in this instance, one half inch vertical and horizontal spacings.

FIG. 10 shows another view of two panels angularly (on which could also be linearly) joined.

FIG. 11 is an enlarged view showing in more detail how the panels of FIG. 10 are angularly joined and held by a coupler and screws or security fasteners.

FIG. 12 is an exploded view of one construction permitting the angular placement, with the end link cap inserted into the vertical frame and a joining link cap fitted there over with screw(s) to hold the panels angularly (or linearly) joined.

FIG. 12 A-C show elevational and two perspective exploded views of one construction of the assembly of the hinge coupler, when used to connect the top of two panels.

FIG. 13 shows two panels joined generally in a perpendicular manner with the end of one held at the top and bottom to the middle of the other, with a third panel at an angle to the middle panel.

FIG. 14 shows in enlarged detail how the lower mid point attachment is made using the midpoint features on the generally perpendicular panel.

FIG. 15 is a view of the upper portion of FIG. 13, but further enlarged and showing the upper midpoint attachment.

FIG. 16 is a partial prospective view illustrating how the grid in one manner, by a bracket, may be removably attached to the vertical frame and how the vertical frame is mounted at its lower end to a leg.

FIG. 16 A an enlarged view of a vertical grid mounting bracket to hold the grid to the spaced openings in the vertical frame member.

FIG. 16 B-D show two perspective and an elevational view of further details for joining the lower end of a vertical frame or post to a leg.

FIG. 17 shows an alternative position for the lower link shown in FIG. 16 and receiving a second vertical member of an adjacent panel.

FIGS. 18 A and B show other alternative stored positions for the lower link shown in FIGS. 16 and 17.

FIG. 19, FIG. 20 and FIG. 21, show various views of an additional form of product hanging, height adjustable, accessory, or display that can be attached to the grid or portion or part therefor.

FIG. 21 A-D shows various elevational views of the clip portion shown in FIGS. 19, 20 and 21.

FIG. 22, FIG. 23 and FIGS. 24A and B show various views of another form of a product hanging accessory that can be attached to the grid.

FIGS. 25 A-D show a simplified form of the accessory shown in FIGS. 22-24, and illustrate yet another form of product hanging height adjusting accessory for attachment to the grid.

FIG. 26, FIG. 27, FIG. 28, and FIG. 29 illustrate yet another form of product hanging height adjusting accessory for attachment to the grid, which has a turnable locking member carries a hook/arm.

FIG. 30, FIG. 31, and FIG. 32 illustrate still a further product hanging height adjustable accessory that can be hung and secured via a pin or screw to the grid.

FIG. 33, FIG. 34, and FIG. 35 illustrate a further rotatable height adjustable product hanging accessory that is lockable onto the grid.

FIG. 36 is a schematic flow chart for the special placement software program for and of the present invention.

FIG. 37 is an illustration of some of the components forming the first embodiment hinge coupler of the present invention, showing the coupler portion with two male projections thereon, one of the female socket inserts that fits within a vertical frame tube of a screen, panel or grid, the center threaded cross pin which hold the socket in the end of the tube and the fastener which secures the one of the male portions in the socket and screws the coupler in place on its socket at a selected position and into the threaded opening in the pin.

FIG. 38 shows two panels (partially) with the upper ends of the two vertical tubes to be connected or secured by the coupler, two socket inserts, two holding cross pins and two fasteners of FIG. 37, prior to assembly.

FIG. 39 shows the components of FIG. 38 assembled with the two screens, panels or grids arranged linearly (180 degrees apart), except the fasteners have not been installed; where the fasteners being used are of an Allen screw type.

FIG. 40 is a full view of the screens or panels and coupler hinge of the present invention shown in FIG. 38.

FIG. 40A is an enlarged perspective, schematic view of an alternative bottom link like that shown in FIGS. 17 and 18A and B, which may be used in conjunction with the top hinge coupler of the present invention.

FIG. 41 is an assembly of two panels FIG. 6 with coupler assembly, fastener handles, and on legs with wheeled casters, the broad double headed arrow (350) indicating that a broad range of angles that the adjacent, connected panels can be set up to hold.

FIG. 42 is an illustration or photograph showing how one of the ends of the tube (foreshortened) can receive the coupler socket insert portion.

FIG. 43 is a photograph showing how the retaining cross pin is fit into openings in the tube and socket insert, with its threaded opening to eventually be axially aligned with the tube and socket axis, and also illustrates the multiple points in the socket which cooperate with the fewer, four, points on the cooperating male projection.

FIG. 44 shows the retaining cross pin nearly or fully put or driven in.

FIG. 45 shows the male projection and its square four points (90 degrees apart) and how it can be engaged into the socket insert (16 points 22.5 degrees apart), this being prior to the latter being positioned in the tube.

FIG. 46, FIG. 47, FIG. 48, and FIG. 49 show how one of the coupler male projection can be selectively positioned in the socket in the tube (here foreshortened for illustration purposes) and fastened together.

FIG. 50, FIG. 51, FIG. 52, and FIG. 53 show how a coupler with its two male projections can be selectively positioned in two socket inserts in or sockets on the two adjacent vertical tube ends of two screens or panels to be coupled together, except the fasteners are not yet installed.

FIG. 54, FIG. 55, FIG. 56, and FIG. 57 show how the coupler hinge of the present invention can be used to position two screens, panels or grids and their adjacent vertical tubes at several relative positions from greater than zero degrees, to 90 degrees, to 180 degrees (linear), to greater than 180 degrees but less than 360 degrees when coupling together two adjacent panels.

FIG. 58 shows an exploded view of a coupler for two adjacent panels but using knobbed fasteners.

FIG. 59 is a schematic of an alternative embodiment for the socket, wherein the socket portion is formed directly or integrally in, as by punching, with or without a die, in the end of the tube forming the frame of a panel.

FIG. 60 is a schematic showing how the square cross pin and tube and socket openings can be indexed to keep the cross pin properly aligned when the fastener is not in place, uses fasteners with handles or knobs thereon, instead of Allen screws so that the coupler hinge may be assembled without the need for tools.

FIGS. 61A-C show an assembly of two perpendicular panels (end-to-middle) with coupler assembly with handle or knob fasteners.

FIGS. 62A and B show assembly detail of two double-sided panel grid tubes to roller castered legs.

FIGS. 63A and B show single tube holder and double tube holder caster legs with slots for adjustable tube holder placement.

FIG. 64 and FIGS. 65A-C show assembly detail of the weld panel grid to the tube frame mounted in castered foot or leg.

FIG. 66A shows four distinct style display hooks, assembled with hanging mounting bracket portions.

FIGS. 66B and C show that each display style hook can be made with various height drops and a side view how such attaches to the grid.

FIGS. 67A and B show an assembly of two perpendicular panels to form a corner with coupler assembly, panels, link or cap, sockets, cross pin, and fastener handles.

FIGS. 68A-C show an elevational and two perspective views and details of a hinge coupler with knob screws and square cross section cross pins links, utilized in FIG. 60.

FIGS. 69A-C are a schematic of an alternate construction, replacing cross pins of FIGS. 60, 68A-C with a construction which wedged tight in the tubes.

FIGS. 70A and B show a plan layout locator board or “plan-o-form” construction, intended for use and may have indicia, such as columns and rows and/or selected silhouetted product/display template displays.

FIGS. 71A, B & C show the method or process of using a plan layout which shows the silhouette of product display and specification.

FIGS. 72A-D show assembly of a mounting bracket (72A), for attaching a shelf (72B) unit to panel (72C-D).

FIG. 73 shows a series of mounting brackets of the type shown in FIG. 72A, numbered 1 to 8, which each has a different vertical drop.

FIGS. 74A-C show a connection of a panel perpendicularly to an end panel using a bottom mount to connect the bottom of the end panel to the side of a foot for the panel. FIGS. 75A-C show assembly of another mounting bracket on a shelf unit (75A and B), and attaching the same unit to panel at various height locations to the grid (75C).

FIGS. 76A-D show assembly of an attachable section of conventional peg board to a panel.

FIGS. 77A-C show assembly of an attachable panel divider onto a panel.

FIGS. 78A-C show an attachment of a solid end wall register panel perpendicularly to a panel with a coupler.

FIGS. 79A-C show the lower assembly of a panel onto a single width foot or leg, bottom mount, and perpendicularly to the solid end register panel.

FIGS. 80A and B show assembly of and an assembled offset panel display module with a 5 inch offset or shelf panel and two register panels, one at each end.

FIGS. 81A and B show assembly of a standard panel with a panel extension section.

FIGS. 82A and B show a panel to be perpendicularly connected to the back of a cooler unit, using an upper mounting top ring that connects via a coupler to the cooler and panel (FIG. 82A) and a lower mounting bracket that connects the leg to the cooler unit (FIG. 82B).

FIGS. 83A and B show assembled views of a panel to the back of the cooler.

FIGS. 84A and B show a panel assembled to side of a cooler.

FIG. 85A shows a cooler surround or cage connected at its back to a panel.

FIG. 85B shows a similar surround, but now connected at one side to a panel.

FIGS. 86A (at back) and B (at side) show details of panel and cooler surround connection of FIGS. 85A.

FIGS. 87A and B show the assembly and assembled additional display rack for the top of a cooler.

FIGS. 88A and B show assembly of a single tube and double tube castered foot connecting bars or bumper rails with quick release “U” shaped snap buttons.

FIGS. 89 and B show the assembled single and double castered feet and connecting bumper rails shown in FIGS. 88A and B.

FIG. 90 shows placement of and placed plastic dust covers for the feet and bumper rails.

FIGS. 91 show details of leg connecting, length adjustable bumper, with standard hinge, pin hinge, and locking button for the length adjustment.

FIGS. 92A to C show assembly of the double-hinged, length adjustable bumper to the castered feet, of linearly connected panels.

FIGS. 93A and B show the assembled double-hinged adjustable bumper, castered feet, and connected now angled panels.

FIGS. 94A and B show a cross section and perspective view of a typical panel having two grids between which a panel product display locator, plan-o-form sheet or board may be inserted to locate product displays on the panel, and shows how the panel locator board insert opening between the grids may be closed by a top cover or cap.

FIGS. 95A, B and C show a preferred form for the coupler assembly using a knobbed or bolt fastener, coupler link with male projection, a female socket with slots, a finned nut fitting into the slots, and an indent indexed tube.

FIGS. 96A and B show an alternative method of adding dividers at the frame post of a panel by upper and lower attachment brackets.

FIGS. 97A, B and C show the addition of the side surround to the side of a cooler.

### DESCRIPTION OF THE PREFERRED EMBODIMENTS

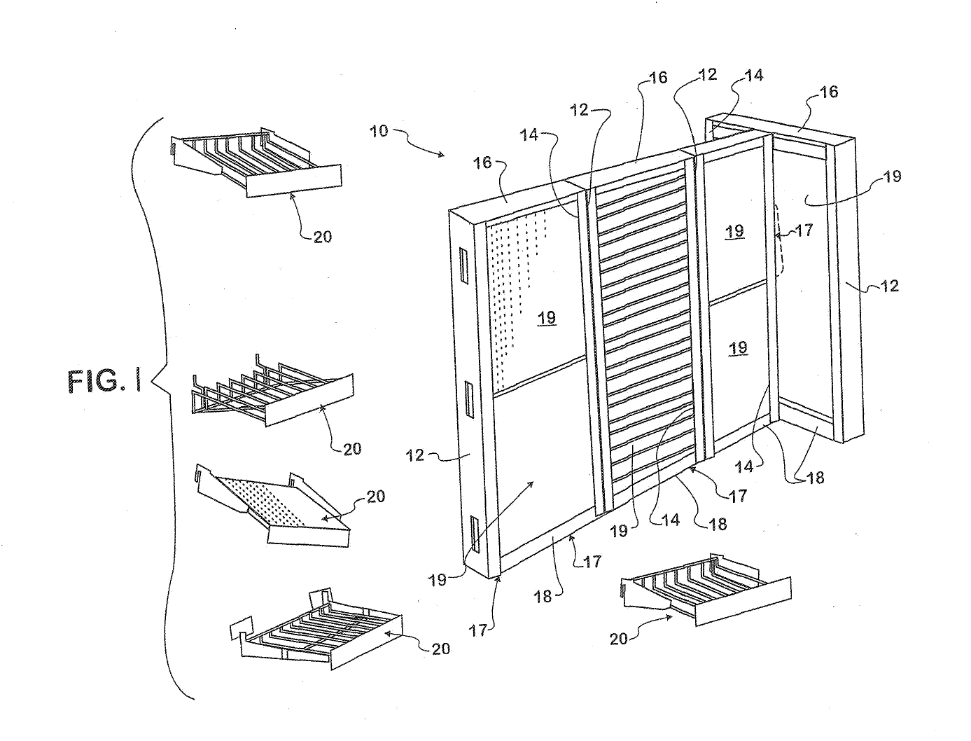

Referring to FIG. 1, a first embodiment of merchandiser 10 is shown and comprises several frame members 12 (right side), 14 (left side), 16 (top) and 18 (bottom) to form a frame carrying panels joined together along with various accessories 20, such as metal (wire shelf) of various forms which can be attached to the merchandiser 10. As shown each frame members 12, 14, 16 and 18 forming a frame carries one or more panels 19 secured to the frame. The frame members 12, 14, 16 and 18 extends around the entire perimeter of the panels 19. Some panels are in forms of peg boards, while others are sheet material. Three of the frames 17 formed by members 12, 14, 16 and 18 are linearly arranged and joined to each other. The end panel 19 and frame 17 is perpendicular to the other three panels.

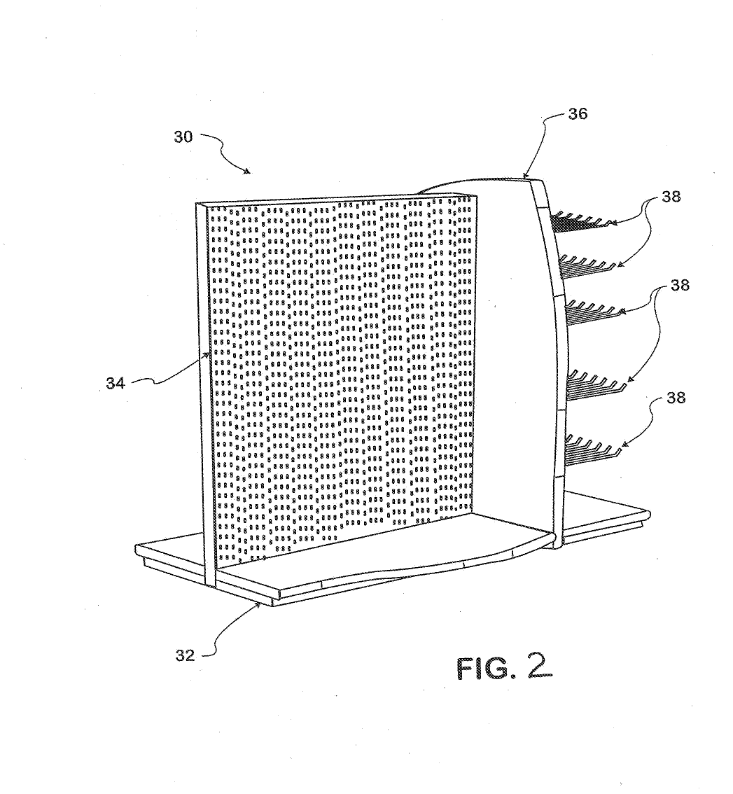

Referring to FIG. 2, another embodiment merchandiser 30 is shown and has a base 32 onto which stands a vertical peg board style panel 34 with holes therein. Attached perpendicularly to the end of the panel 34 is another panel 36. As can be seen various shelf or other product display accessories 38 can be attached thereto. Likewise, various accessories can be attached to either side of panel 34.

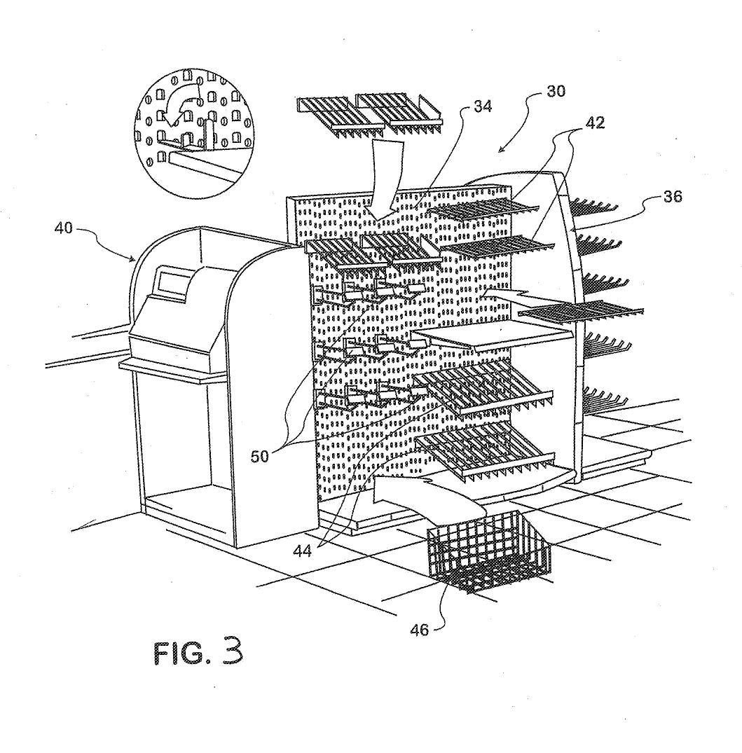

Referring to FIG. 3, the merchandiser 30 is shown in a retail environment forming a front end merchandiser placed adjacent and next to a cashier or checkout station 40. As shown in FIG. 3, additional accessories such as wire shelves 42 inclined wire shelves 44, wire basked 46 and a plurality of single product hooks 50 are attached to panel 34. As shown in the circular detail, the accessories carry two or more male prongs which fit into the female opening into the peg board style steel panel 34. Any of the merchandisers shown in this application, and particularly those shown at FIG. 6 and later, could also be used to form a front end merchandiser at or near a cashier or checkout station.

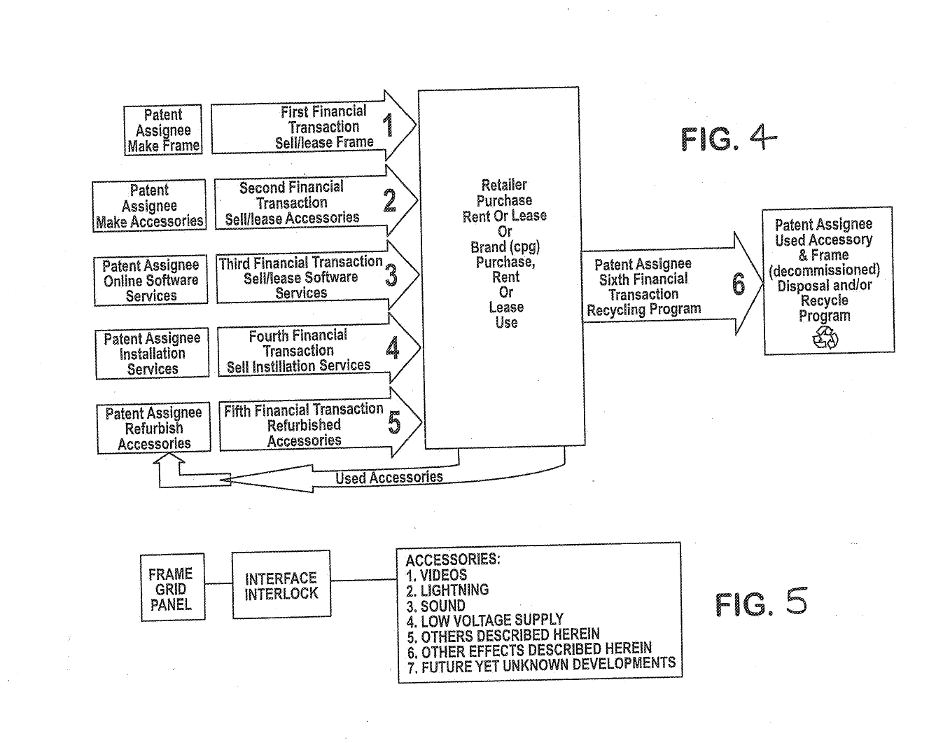

FIG. 4 is a schematic diagram illustrating the multiple transaction aspect of the present invention, wherein a frame and/or panel, and optionally some accessories therefore may be sold or leased in a first financial transaction. Then, subsequently, additional accessories or frames and/or panels may be acquired in a second and/or subsequent financial transaction. When it becomes time to update, new panels and/or accessories can be acquired in a subsequent transaction and added to or used to replace the existing frame. The replaced accessories can be recycled and/or reused elsewhere. Likewise, after the initial install, subsequent updates can be more easily, less expensively, more quickly made, with less disruption of the location, and more environmentally friendly because less material needs to be disposed.

FIG. 5 is a schematic illustrating how a frame/base having a panel of the present invention can have interfitted and installed thereon various accessories or devices, such as product hangers, shelves, brackets, racks, including any others mentioned therein or herein.

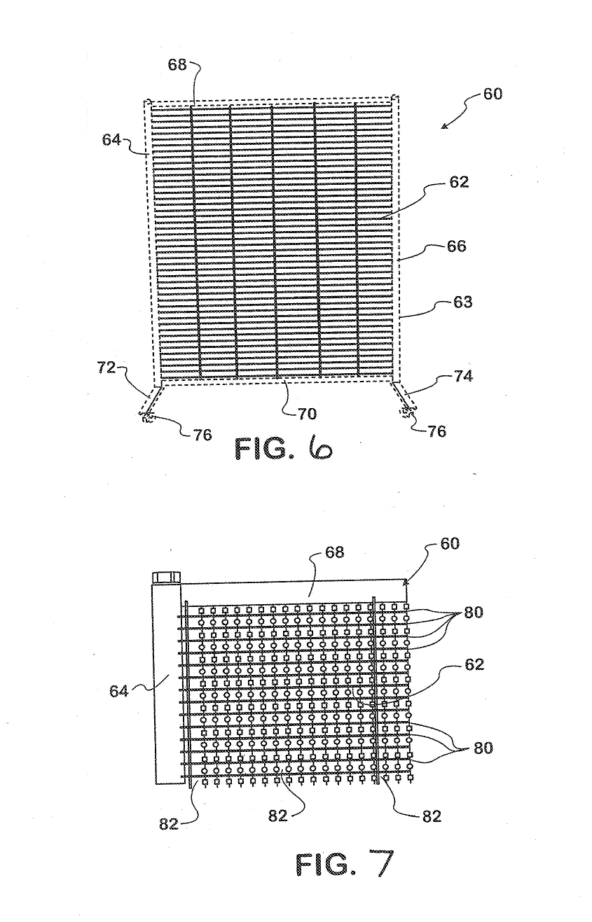

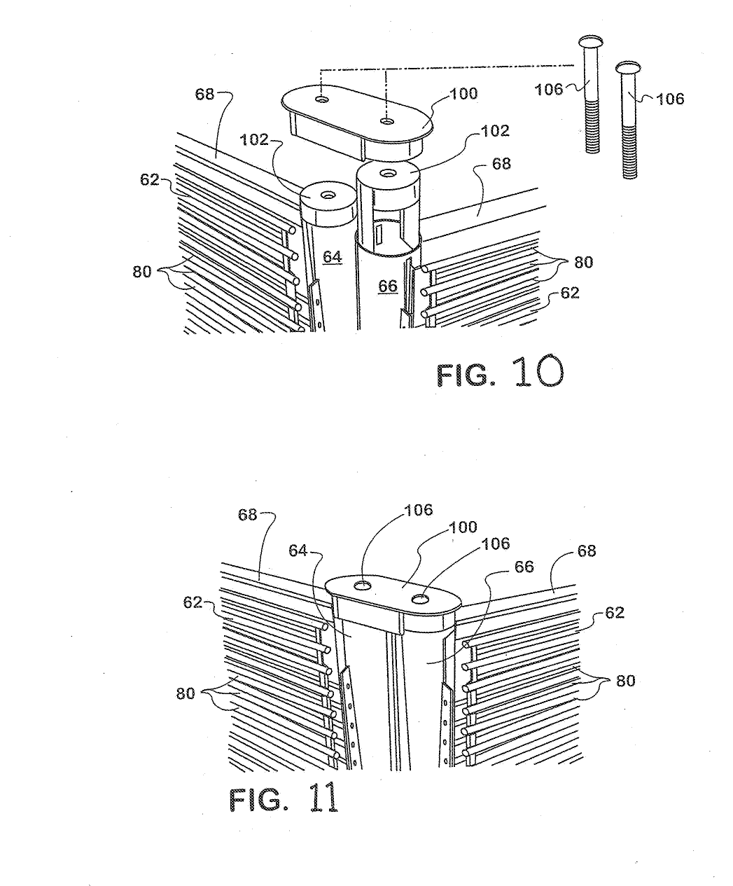

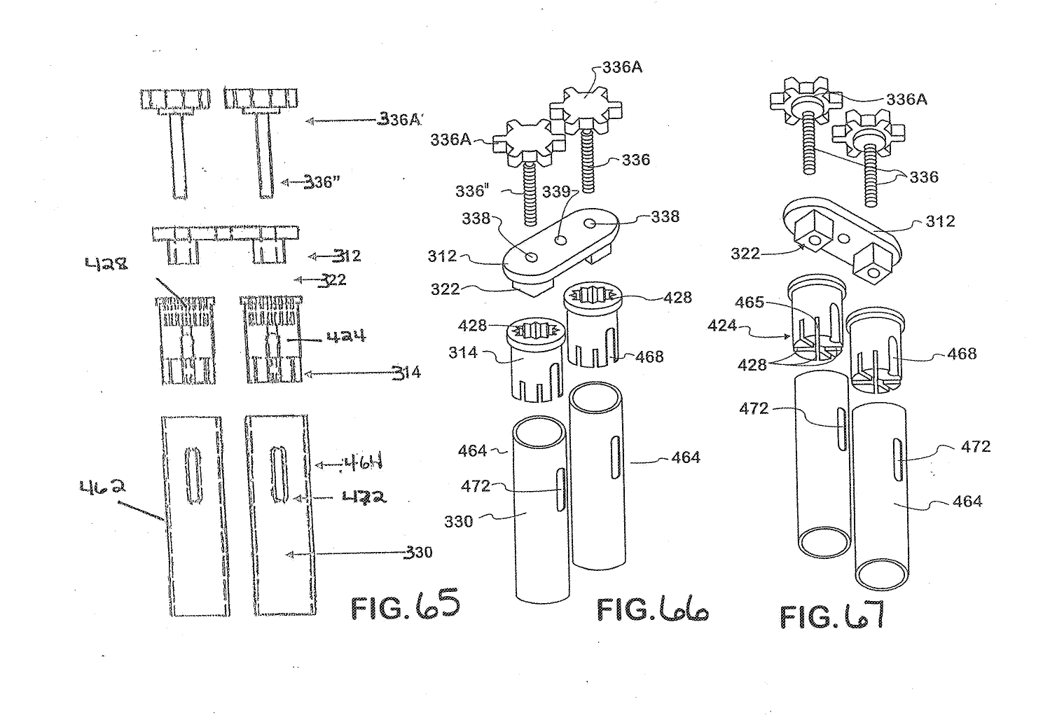

FIG. 6 illustrates a preferred form of frame/base 60 carrying at least one, and preferably two, grill or grid style panels 62 spaced from ¼ to ½ inch or more apart. Of course, frame/bases with but a single grid can be used as will be described below, for example, in connection with a cooler surround. The grills or grids 62 are secured to the frames 63 for example by clips, or preferably welding. The frame 63 comprises a perimeter of two vertical tubes or posts 64 and 66 closed by upper and lower horizontal members 68 and 70. The former 68 could be a removable cap to gain access to the space between the grids. The bottoms of the vertical posts 64 and 66 can be mounted on a pair of horizontal feet or legs 72 and 74 at their midpoints. The outer ends of the legs 72 and 74 may carry casters or glides 76 for ease of movement. Referring to FIG. 7, the grill or grid 62 can be made up of horizontal wires or bars 80 spaced say 2 inches apart vertically, tied together with vertical wires 82 from 6 to 8 inches apart. The grid and panel 62 can be of, for example, as narrow as 1½ to 2 feet and 4 feet or more wide and say 54 to 63 inches high. Of course other dimensions could be used. The panel could be formed of two or more vertically stacked grids, each of a height of say from 10 to 36 inches or more, preferably 14 to 24 inches and preferably about 18 inches in height. Preferably the panel is made of a pair of full size grids 62, welded with a space there between to its frame 60 of two end posts 62 or 64 and lower frame member 70, like shown in, for example, the two shown in FIGS. 10 and 64. Of course, any custom size grid can be made.

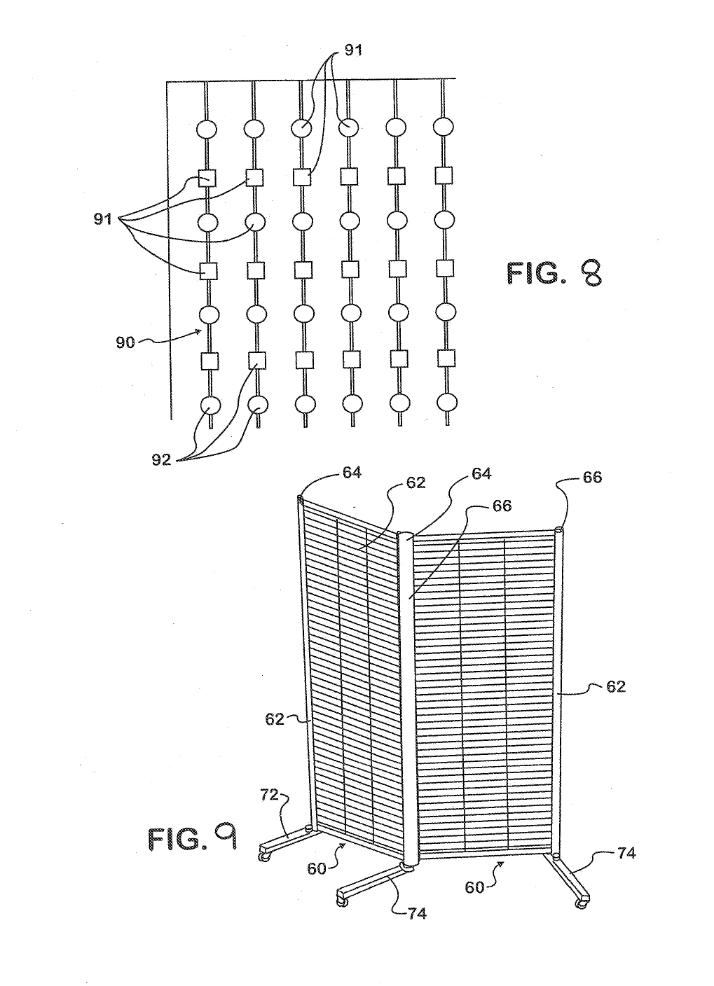

Referring to FIG. 8 and FIG. 9, the grid 62 shown in FIG. 6, can be backed by an index or indicia panel 90, which contains or carry indicia 91 making it possible to accurately locate accessories and product displays on the base/frame panel 60 and grid 62. Preferably, the indicia panel 90 is in the form of the product display silhouette panel, such as shown in FIGS. 71A to C. If the panel is to be exposed on both sides two grids 62 can be used to sandwich the index panel 90 in the space there between.

Referring to FIG. 9, the index or indicia 91 in this instance, is spaced ½ inch apart, but could be as low as ¼ inch apart, vertically in columns and horizontally in rows. Of course other spacings or arrangements could be used.

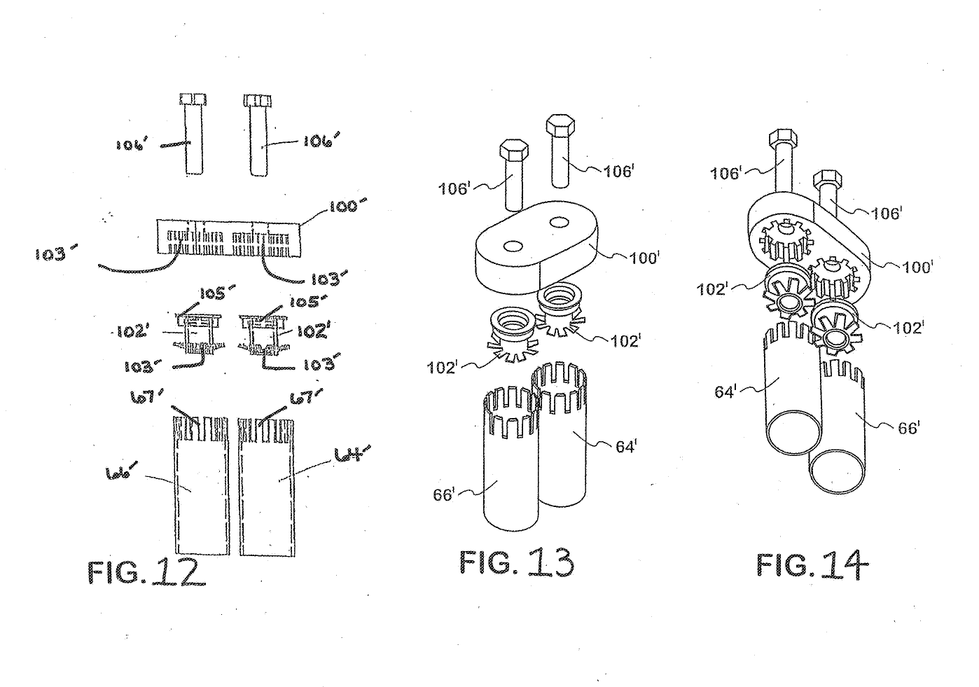

Referring to FIG. 10, two panels 60/62 as shown in FIG. 6, can be angularly (from about 10 degrees to about 350 degrees) or linearly (180 degrees) joined together. The manner of joining is shown in FIG. 11 and FIG. 12 for the upper end of the vertical posts 64 and 66. To do so a joining link cap 100 fits over the closing caps 102 of two adjacent posts of the adjacent panels. The caps 100 or 102 have opening 104 to receive bolts or screws 106 which can be threaded into a member welded, held or pressed into and inside the top or bottom ends opening of the tubular posts 64 and 66. The lower end of the two adjacent posts can be joined angular or linearly to feet or legs 72 as is shown in FIG. 17. There the bottoms of the two adjacent vertical posts 64 and 66 fit into adjacent opening in the bottom connecting link 120, which has a lower lip to support the bottom of the tube. Further details of this upper connection can be seen in FIG. 12 A-C.

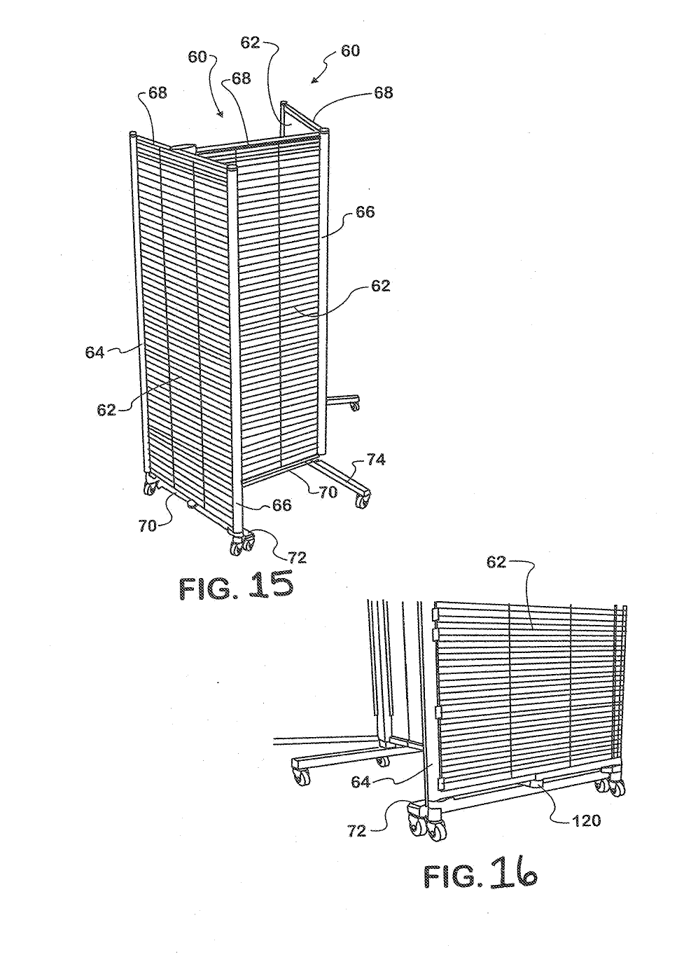

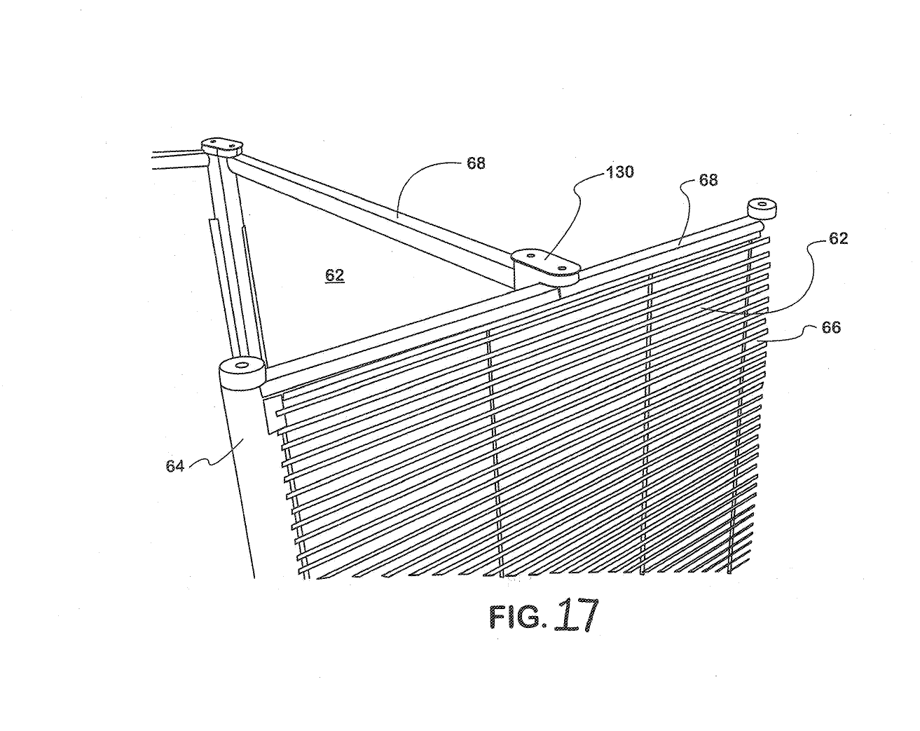

Referring to FIG. 13, two panels may be joined perpendicularly with one panel so joined at or near the midpoint of the other. The lower perpendicular connection is shown in FIG. 14 with a joining bottom link or cap 120 having two adjacent openings or holes 122 to receive the bottoms of the vertical posts 64 or 66 of the panels. One of the openings can also receive a stub 124 extending upward from the midpoint of the leg 72. The upper perpendicular connection is shown in FIG. 15. There a joining link or cap 130, which could be like link 100 or 100′ at the midpoint of the perpendicular panel, which also receives the upper end of the vertical end post of the adjacent panel and a stub at the midpoint of the top of the perpendicular panel.

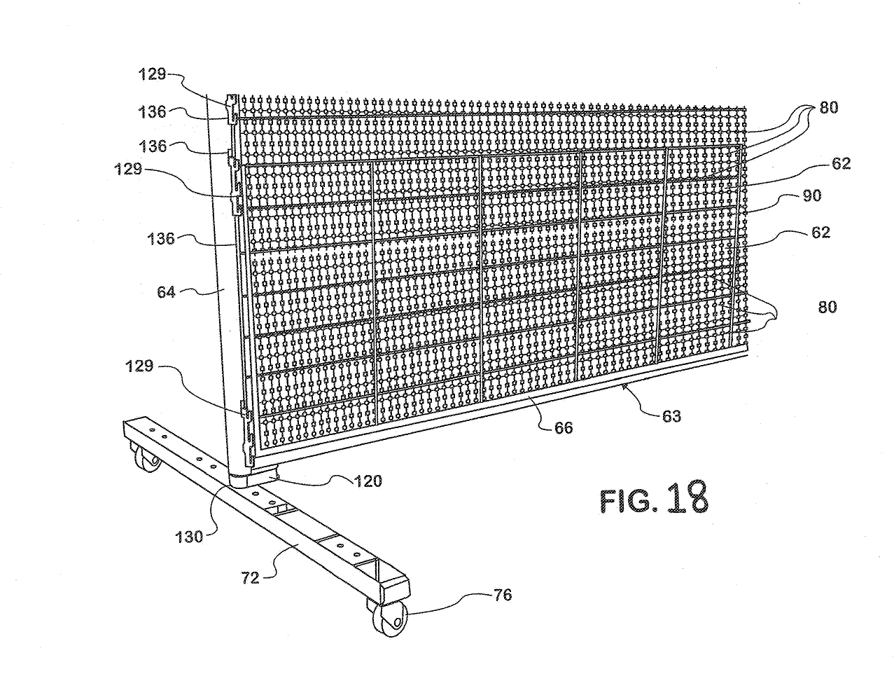

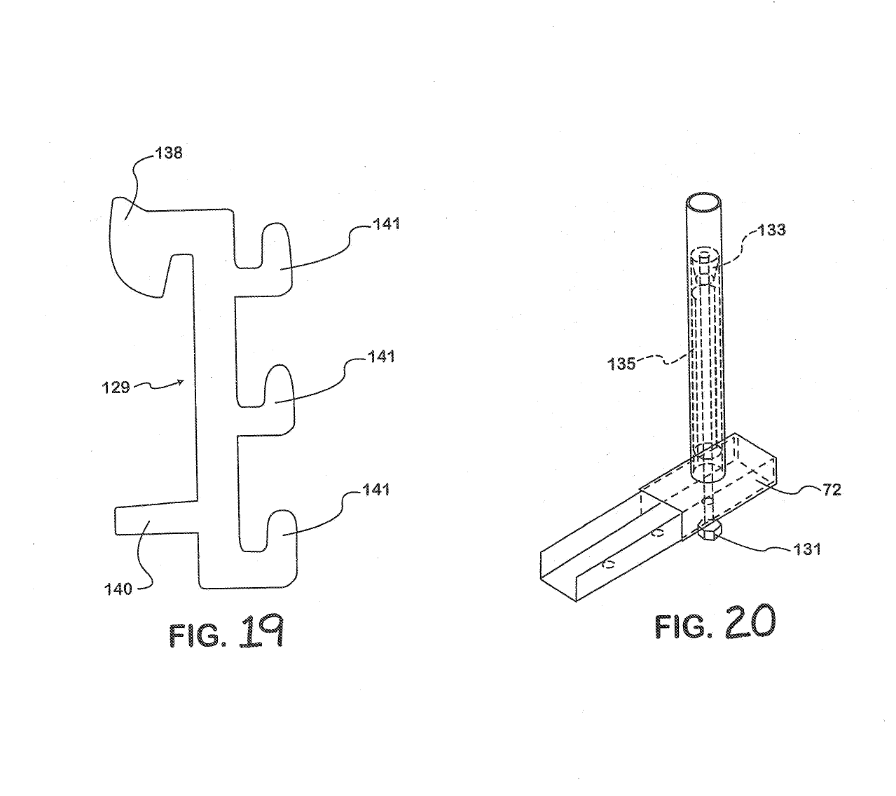

Referring to FIG. 16, enlarge detail of the leg 72, vertical post 64, frame, grid 62 and indicia panel 90 is shown. The grid may be secured by brackets 129 (see FIG. 16A), which in turn are secured to or hang from the vertical posts (64 or 66) of the frame. As shown the leg 72 is a horizontal beam element with a vertical opening 130 for receiving the bottom of the vertical post (64 or 66). Between the top of the leg and the bottom of the frame for the grid, a connecting link 120 is provided. The link 120 is similar to the link shown in FIG. 40A. To facilitate mounting of the bracket 129, the vertical posts 64 and 66 have vertically spaced opening 136 (see FIG. 16) to receive the hook 138 and pin 140 portions of the bracket 129. Alternative positions for this connection link hook are shown in FIG. 17 and FIGS. 18A and B, the former accommodating linear or angular joining of two adjacent panels. Further details of attaching a vertical post 64 or 66 to a leg are shown in FIG. 16B-D and include a bolt 131 which is screwed into a member or nut 133 that wedges an insert 135 tight in the post. If a lower hinge 120 is used, the vertical post or tube 64 or 66 is slipped into one or the other of the adjacent opening 122 (see FIG. 18B) in the lower hinge link 120. To hold the bracket 129 to the posts 64 or 66, the bracket has the hook 138 and pin 140 which engages in two hole 136. The bracket 129 also has a series of grid hooks 141 which engage the horizontal wires or bars 80 of the grid.

Preferably the grid can be welded to its frame, including mainly to the posts 64 and 66.

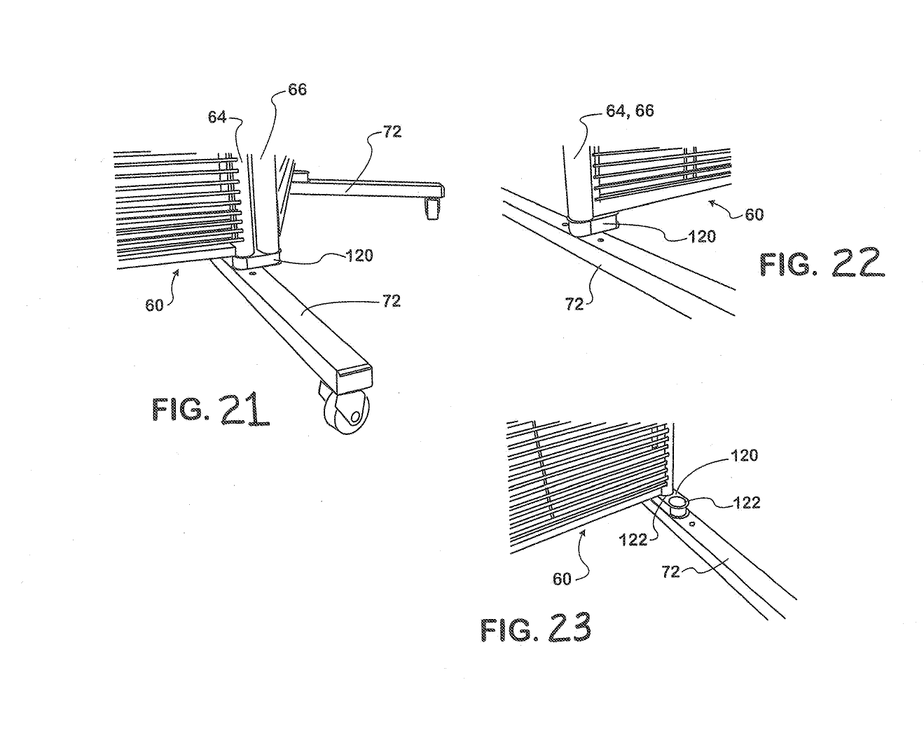

Referring to FIG. 19, FIG. 20, and FIG. 21, they show a height adjustable product hanger 160. The device companies a bracket 162 portion (see FIG. 21A-D for details) having two hooks 164 and 166 which can be placed over the horizontal wires or bars 80 of the grid, and held in place by a screw 168 (or other type fastener) threaded into an opening into the bracket to trap an upper bar 80 of the grid. The screw 168 (or other fastener) can have a special security design or provision that requires a special tool for installation or removal so as to prevent theft. The device includes a central “U” shaped portion 170 which has one leg forming a product hook 172, and the other leg forming a price tag carrier/safety protrusion 174, with a bent outer end. For example, if a shelf or basket or other display accessory is used, it could have a complimentary “U” shaped portion to fit within the bracket portion 162. The same screw 168 that secures the bracket 168 can be used to hold the middle “U” shaped portion 170 in relative height adjustment of the product hook 172/174 with respect to the bracket 162 and hence to the grid. One would loosen the screw 168 to make a height adjustment then retighten the screw 168 at the desired level. These “U” shaped portions can carry height adjustment indicia. Alternatively, the indicia may be placed on the bracket 162.

FIG. 22, FIG. 23, and FIGS. 24A and B show another form of product hanger 180. This hanger is generally “U” shaped and on each leg has a plurality (here more than four) of hooks 182 with slots there below to receive the horizontal bars 80 of the grid, by selecting different slots height adjustments can be made. Other product display accessories can be attached to one or more of the central openings 186. These openings too can be used for height adjustment. Small products could be supported by a single hanger 180, while large one could use two or more.

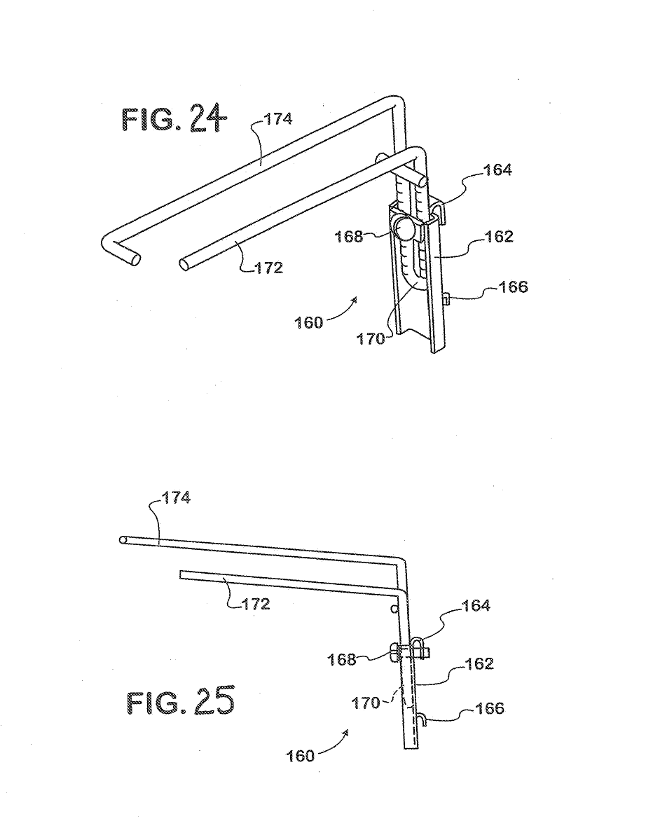

A simplified hanger 190 is shown in FIG. 25 A-D and has a few grid hooks 192, four, spaced apart the distance between the horizontal bars 80 and a elongated, center opening 194 providing height adjustment to which other devices may be attached by a screw or bolt (not shown).

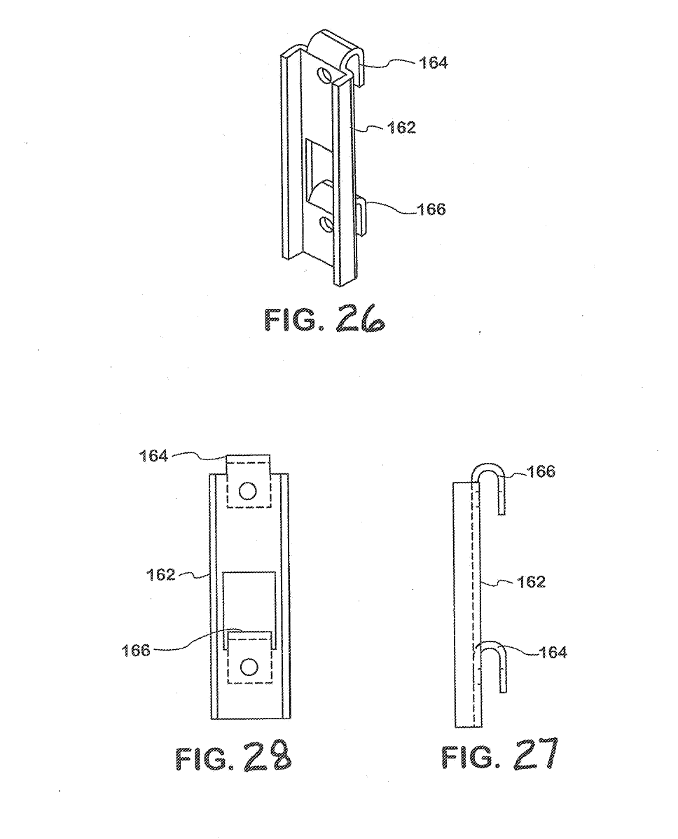

Referring to FIG. 26, FIG. 27, FIG. 28, and FIG. 29 another product display accessory hook 200 is shown. It has a rotatable bar 202 with can be turned to engage two of the horizontal bars 80 of the grid. The rotatable bar is shown in FIG. 26, which can pass horizontally by the horizontal grid wire or bars 80. In FIG. 27, FIG. 28, and FIG. 29 it is shown in a locked on position on the grid. The hook 201 thereof is bent at right angle and has an inner portion 204 a series of vertically spaced holes 206 therein to provide relative height adjustment. To hold the height adjustment a pin member 208 engages in one of these holes. When the retainer 210 is rotated to the locking position, it also abuts and retains this pin 208 in place to hold the height adjustment.

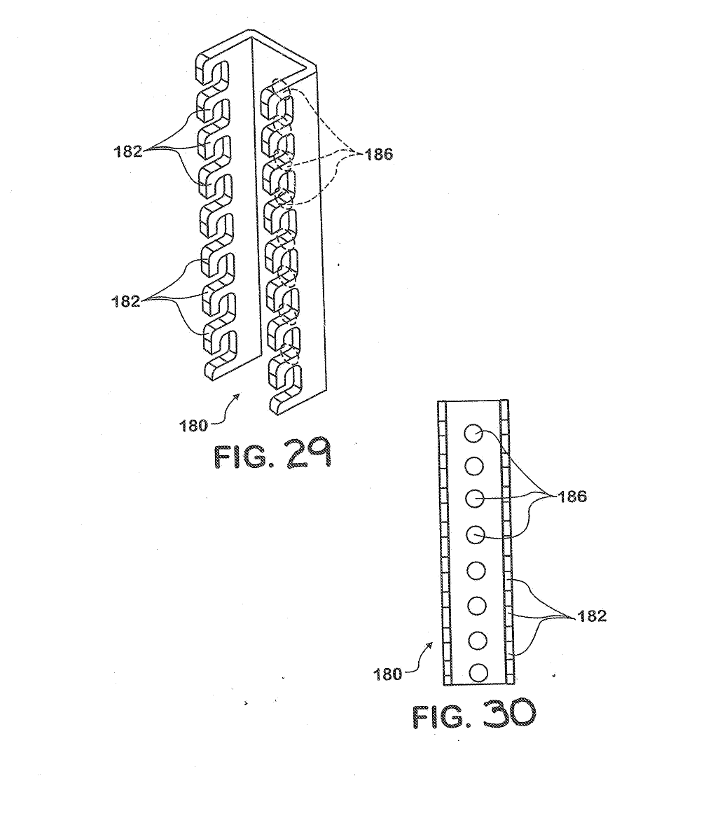

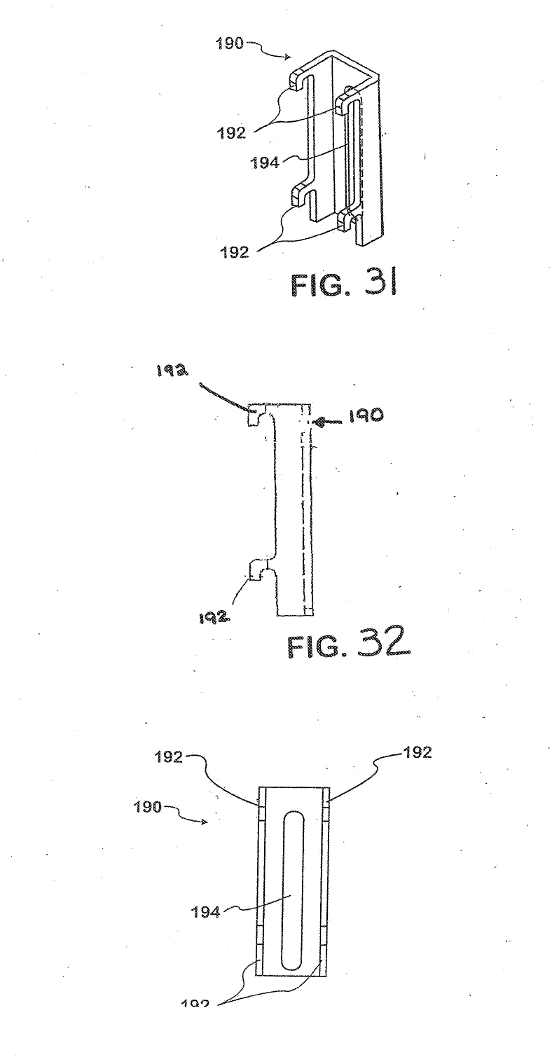

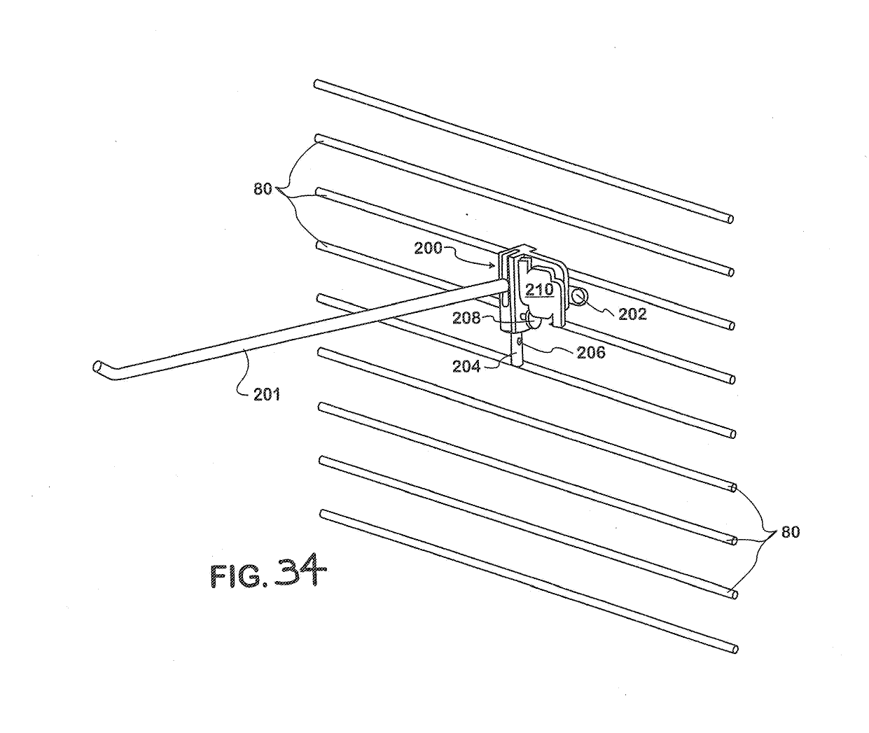

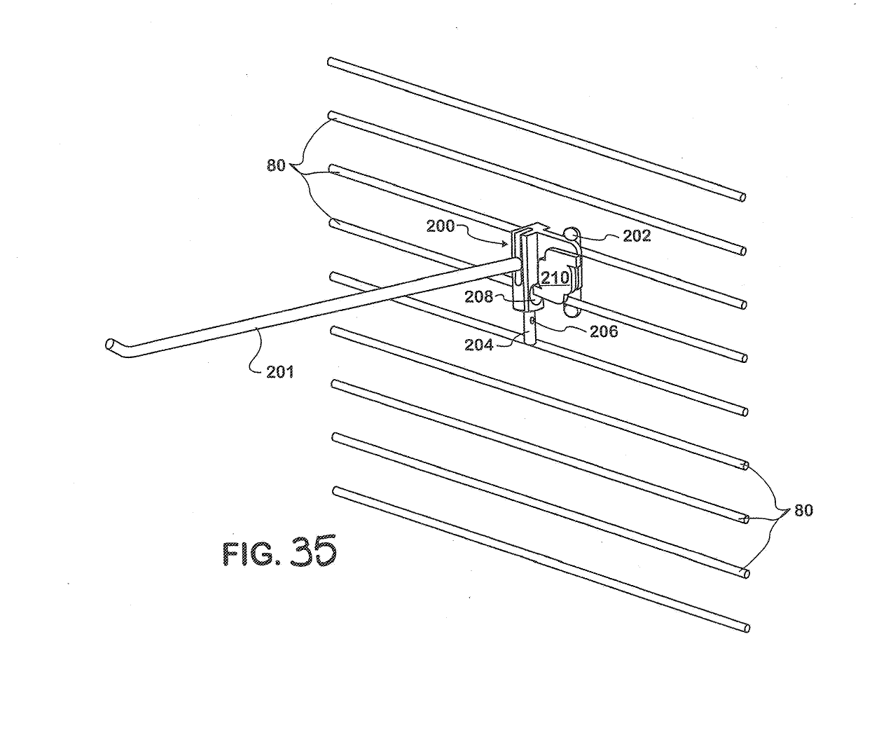

Referring to FIG. 30, FIG. 31 and FIG. 32 another height adjustable bracket/hook accessory 220 is shown and has a product hook 221 and hook 222 on the top of the bracket which hangs from one of the horizontal wires or bars 80 of the grid. To lock the hanger in place a pin or screw 224 is provided and it traps the bar 80 in place. The hook is relatively height adjustable, and to this end, its vertical inner end has a series of vertical holes 225 into which a nipple 226 (stamped into the bracket) can protrude to hold the height adjustment. The upper end of the vertical portion is fit into sliding “U” shaped portion 228 engaged in the bracket. To adjust the same, the leg hole or 225 opening is disengaged from the nipple 226, the hook is slid to a new position and a new opening thereof is aligned and inserted on the nipple 226.

Still another form accessory product hook 240 with a product hanging hook 24 is shown in FIG. 33, FIG. 34, and FIG. 35. This accessory includes a rotatable member 242 having a series of (here five) hooks 244 to 248 of different relative vertical height upon which the accessory hangs from a top horizontal bar of the grid that accomplishes the height adjustment. By selecting various ones of the radially placed hooks 244-248 different heights can be achieved. To hold the accessory in place a lower vertical cross bar 250 on a rotatable pin 252 is provided. With this cross bar 250 turned from horizontal to vertical, it can trap two of the horizontal wires or bars 80 of the grid to hold the accessory 240 in place. To accommodate possible vertical alignment, the pin engages in a “U” shaped portion 254 of the hanger 200.

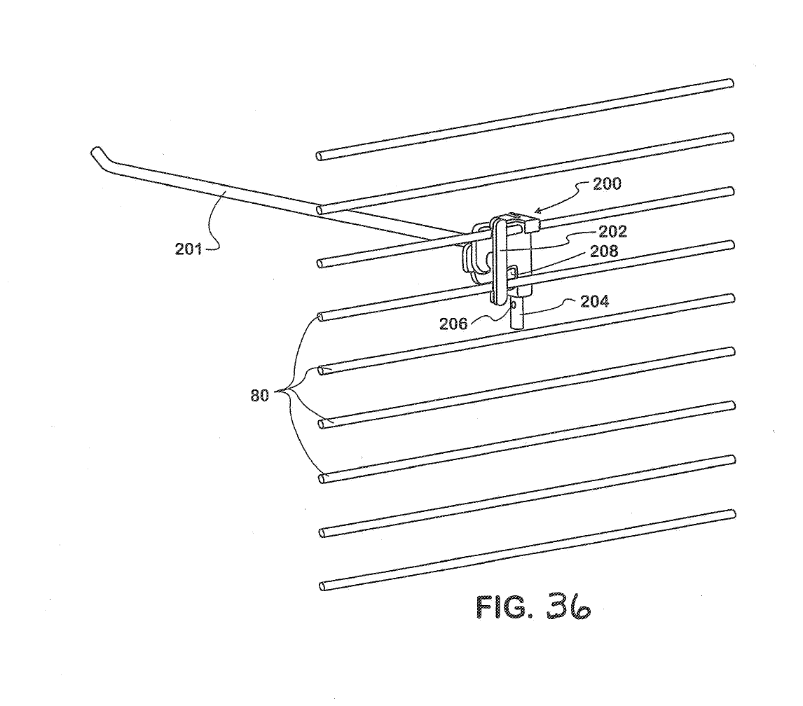

Referring to FIG. 36, a flow chart for the software special planning program is shown. This software can be made available in the initial or subsequent financial transaction, and by lease or sale, or provide as a service on any known media. The software permits the merchant to make trial layouts, and once one is approved, say at the corporate level, copies of that layout sheet printed out or electronically or digitally sent to locations to exactly duplicate the chosen layout using the indicia contained in the indicia 90 for the panels.

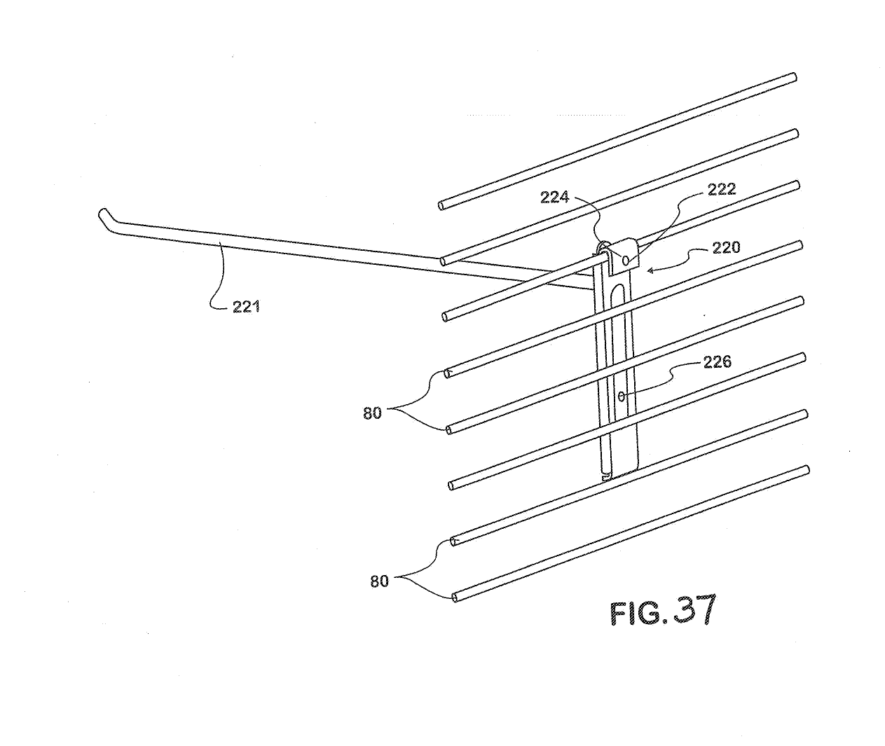

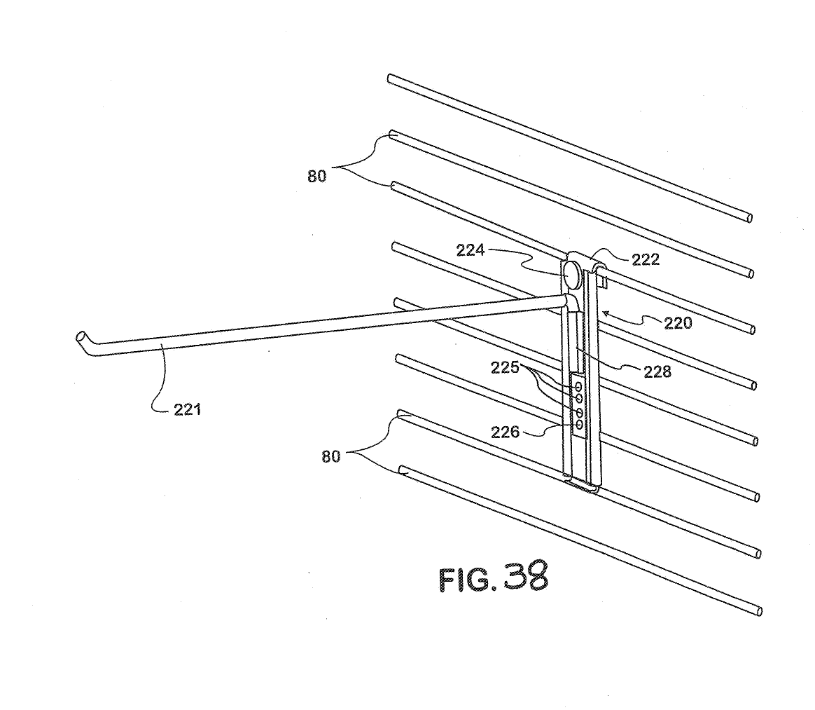

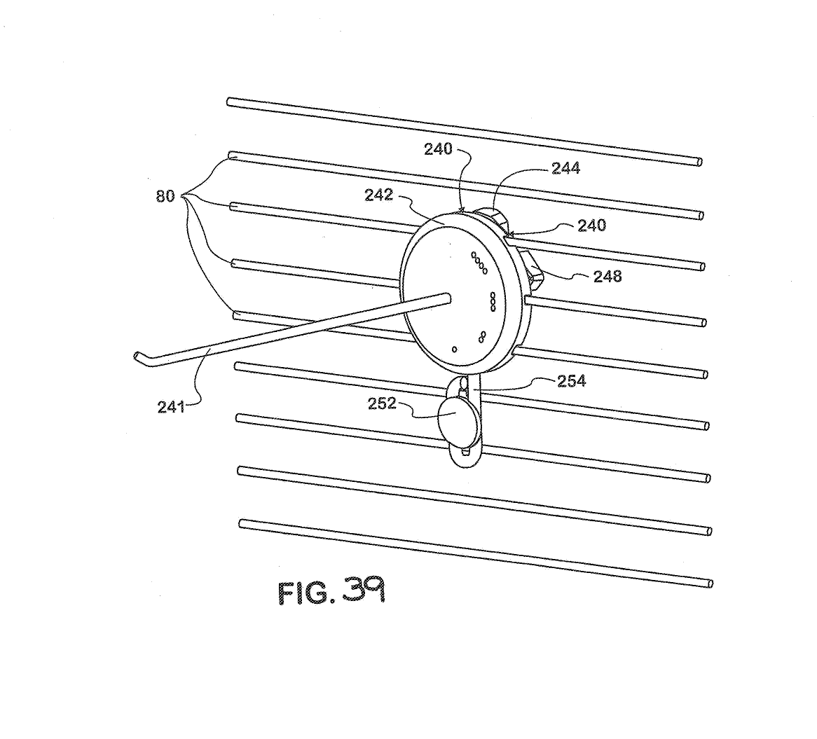

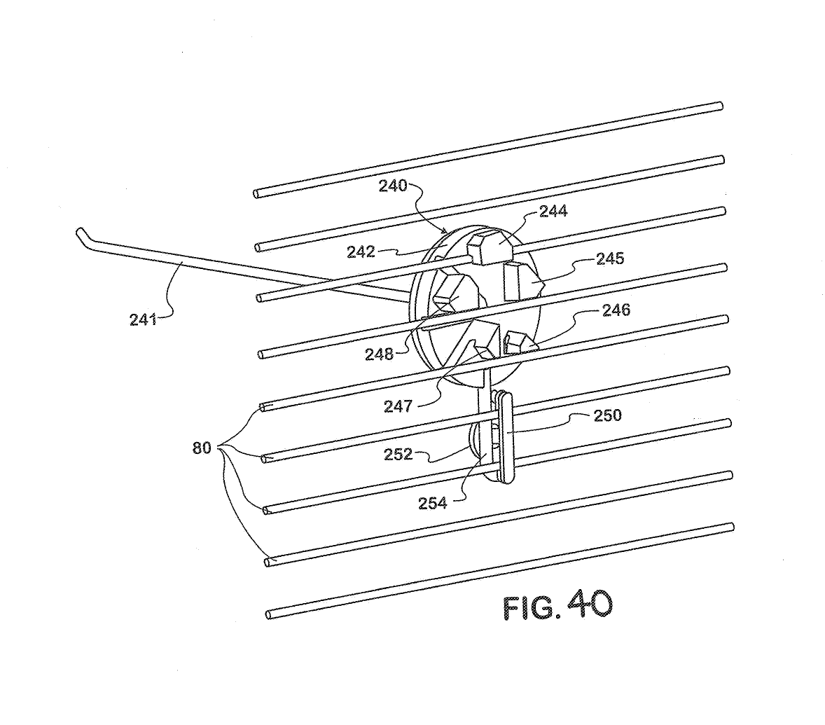

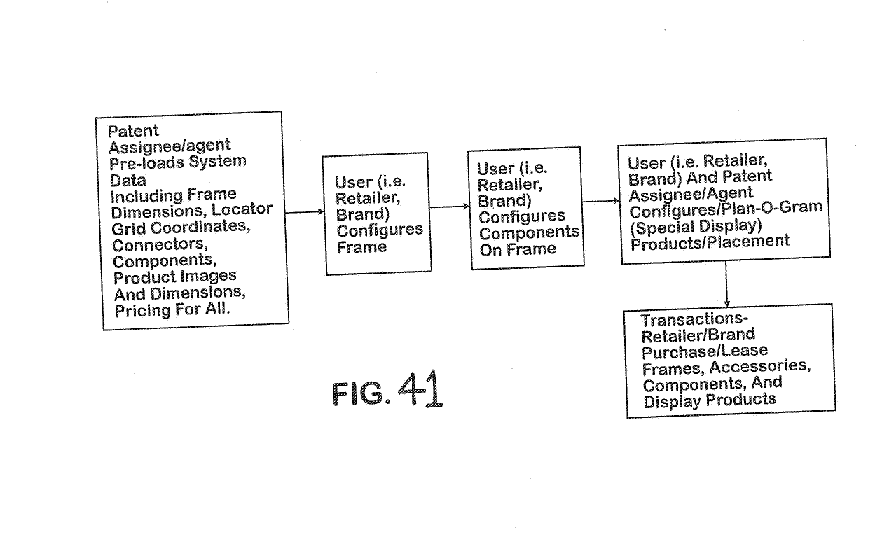

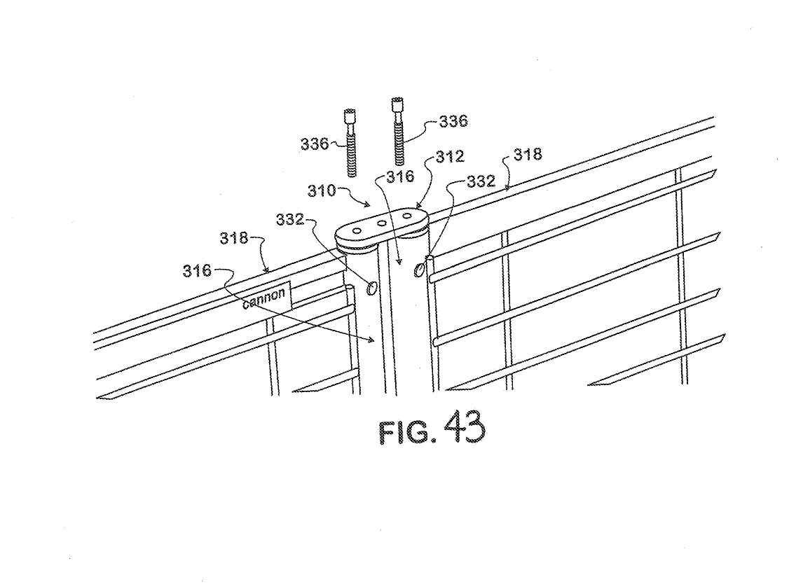

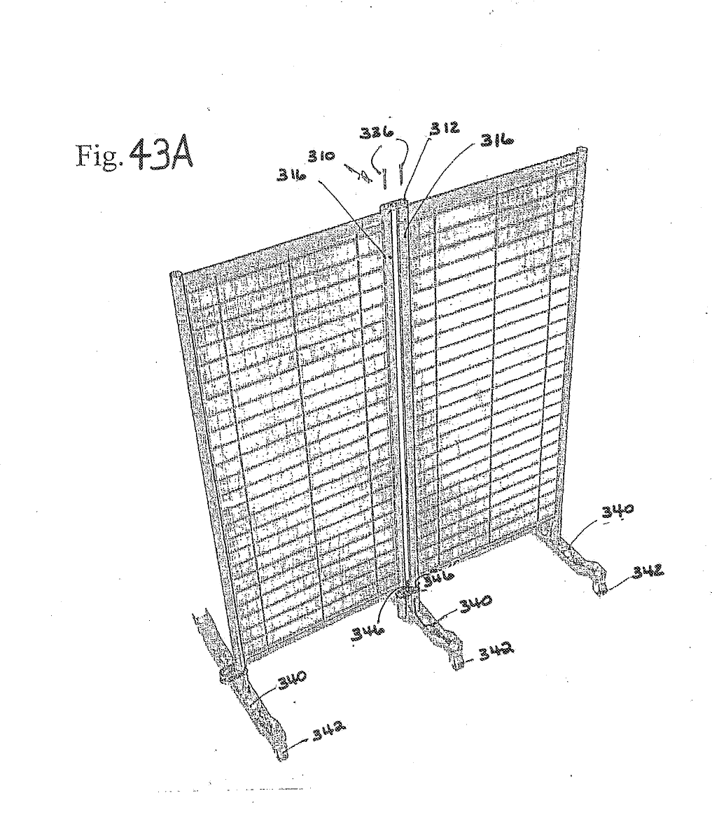

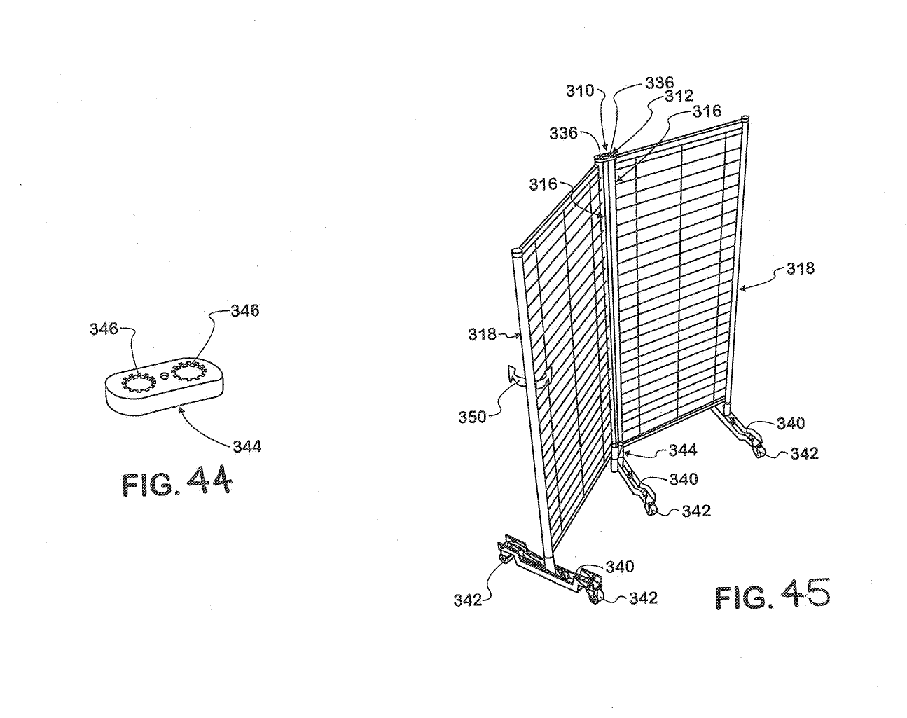

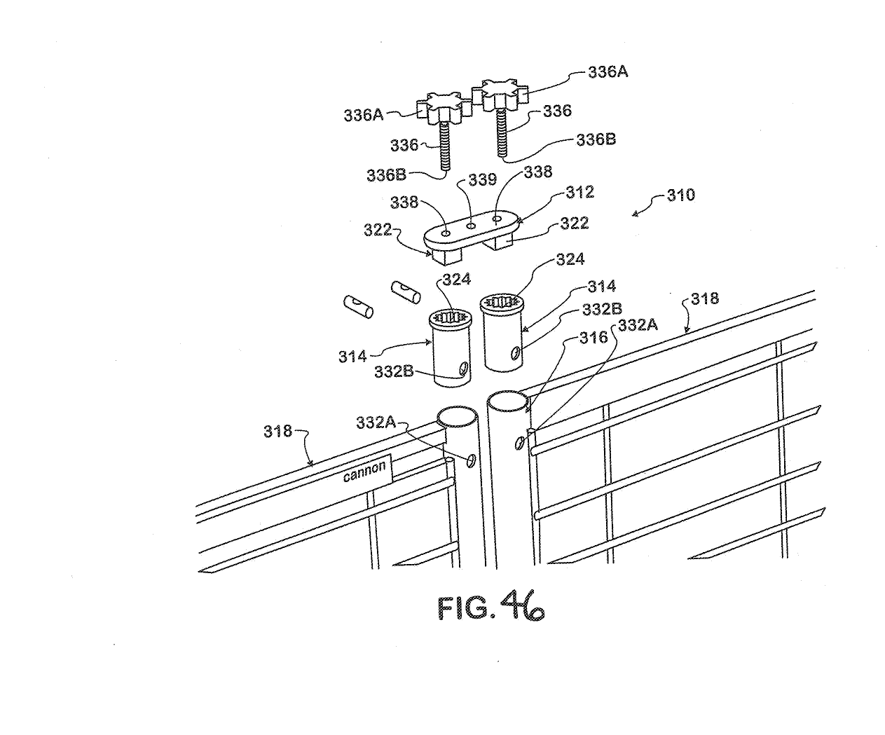

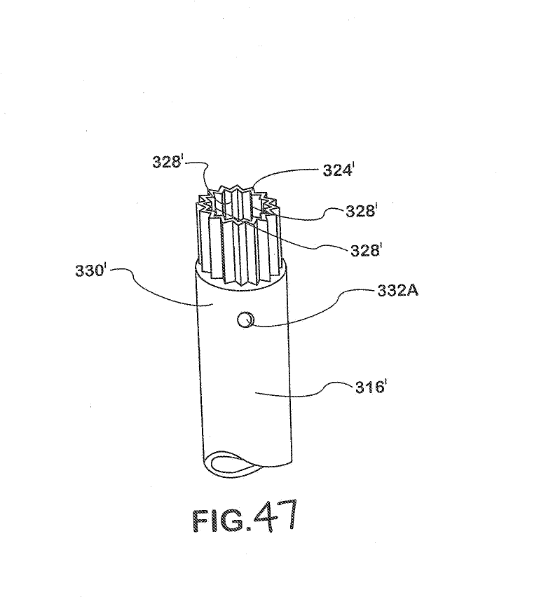

Referring to FIGS. 38 to 57, improved upper hinge couplers or links 310 of the present invention is shown. This is an improved from and over the upper hinge coupler shown in the prior referred to Provisional Application Ser. No. 61/337,039. As noted in FIG. 38 and shown in more detail in FIG. 37, the hinge coupler 310 comprises a link or hinge coupler element 312 and a cooperating or receiving insert or body 314 for joining two vertical tubes or members 316 of two screens, panels or grids 318. It should be noted as disclosed below a socket portion thereof could be provided directly on or integral with the tubes 316 of the panels 318 joined by the coupler 310. The hinge coupler 312 and cooperating insert or receiving body 314 are in the form of a two male projection 322 and female sockets 324. In this instance, the male projections are at the ends and on one side (bottom) of the link 312 and the sockets 322 are in the center of the top or outer ends of the cooperating receiving body or insert 314. While there could be equal number of male points and cooperating female recessed points for receiving the same, in this instance there are four points 26 at 90 degrees apart forming the male projection (an easily formed square), while the socket has 16 female recesses or points 328. Thus, the relative relationship between the points can be changed by 22.5 degrees (360 degrees divided by 16). Of course, other arrangements of male points and female points could be used and are shown in the table below (the small arrows in the table indicating the table could be continued):

Relative Angular Degree Change

| | Female | Socket Multiplier Male points | | | | | |
|---|---|---|---|---|---|---|---|
| Male points | points | 1 | 2 | 3 | 4 | 5 | 6 → |
| 2 | | 180 | 90 | 60 | 45 | 36 | 30 |
| 3 | | 120 | 60 | 40 | 30 | 24 | 20 → |
| 4 | | 90 | 45 | 30 | 22.5 | 18 | 15 → |
| 5 | | 72 | 36 | 24 | 18 | 14+ | 12 → |
| 6 | | 60 | 30 | 20 | 15 | 12 | 10 → |
| 7 | | 51+ | 25+ | 17+ | 12+ | 10+ | 8+ → |
| 8 | | 45 | 22.5 | 15 | 11+ | 9 | 7+ → |
| 9 | | 40 | 20 | 13+ | 10 | 8 | 6+ → |
| 10 | | 36 | 18 | 12 | 9 | 7.2 | 6 → |
| ↓ | | ↓ | ↓ | ↓ | ↓ | ↓ | ↓ |

FIG. 38 shows complimentary set of components, including two panels 318, which are here shown linear, but could be arranged at any angle herein described, these have frames formed by end tubes 316, herein vertical, the two socket inserts 314, with sockets 324, the link 312, with two male projections 322 and fastener openings 338. Also shown are the two retaining cross pins 332, with center threaded openings 334 to receive fasteners 336 (here screws). Also shown in the tube and inserts are openings 332A and 332B into which the cross pin 332 fits. The pin and these openings could be index to keep the pin properly aligned to receive the fastener. For example, the pin and openings could have non-circulation cross sections for at least a portion, or both could be of a non-circular cross section, such as the square cross sections shown in FIG. 60.

FIG. 39 shows the hinge almost fully assembled, except for the fasteners 336 being put in place.

FIG. 40 shows a full view of the panels 318 of FIG. 38 and FIG. 39, again without the fasteners 336 installed. Note, the panels are supported by legs 340 on rollers or casters 342, and the bottoms of the panels tubes 316 are joined by a large link 344 having two circular 346 openings to receive the tubes 316 and is shown in FIG. 40A.

FIG. 41 shows how the screens or panels 316 can be placed in different relative angular positions when the hinge coupler 310 of the present invention is disassembled, the panels and hinge moved, and then the hinge reassembled. Note also that the fasteners 336 have been installed. The broad arrow 350 schematically indicates the other possible stepped angular placement of the panels 318.

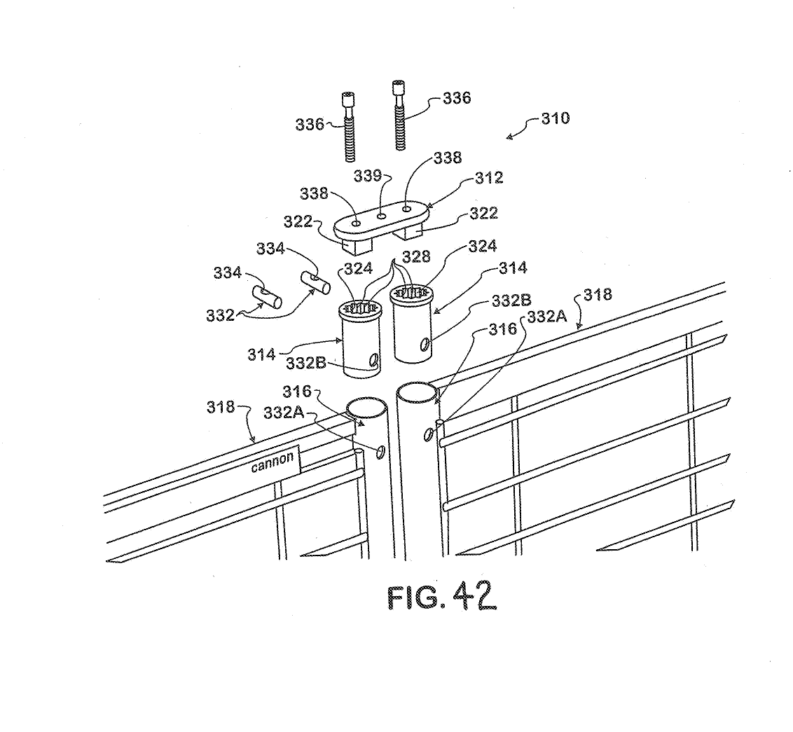

FIG. 42 to FIG. 49 show how some of the hinge coupler 310 components are assembled. The socket insert 314 is held in the end 330 of the tube 316, by the retaining cross pin 332. The retaining pin has a central threaded opening 334 which will receive the fastener 336 to hold the pin in the tube 316 and the insert 314 in the tube, with the coupler link 312 and its male projections 322 in the female socket 324. The socket insert 314 and tube 316 have cooperating openings 332A and 332B to receive the pin 332. To accommodate the fastener 336, the link 312 is provided with openings 338 which pass through the male projection 322, the sockets 324, insert 314 and/or into tube 316, and engage with the threaded opening 332B in the cross pin 332.

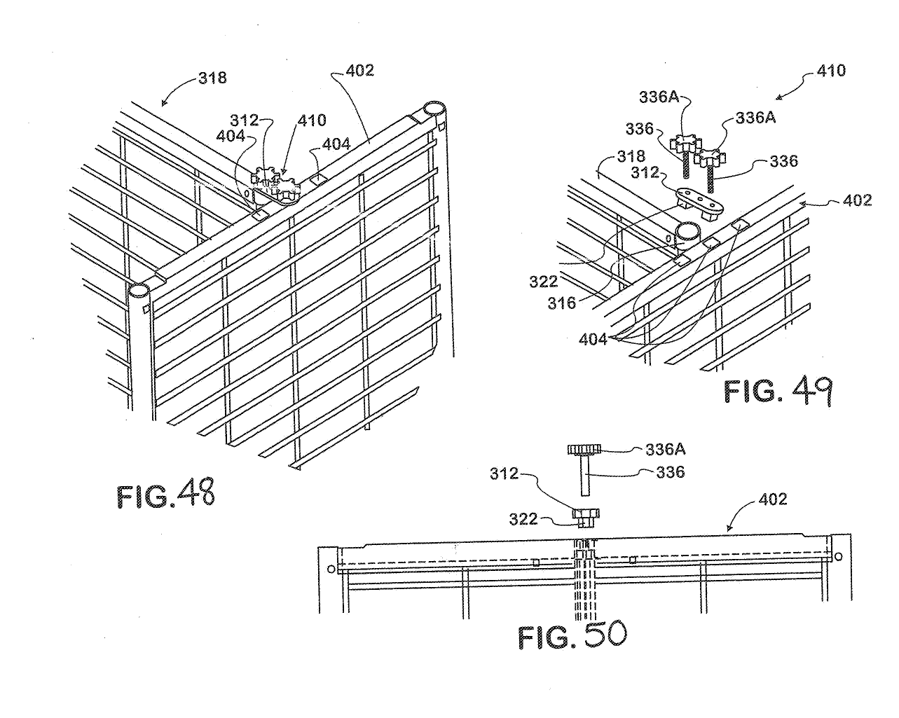

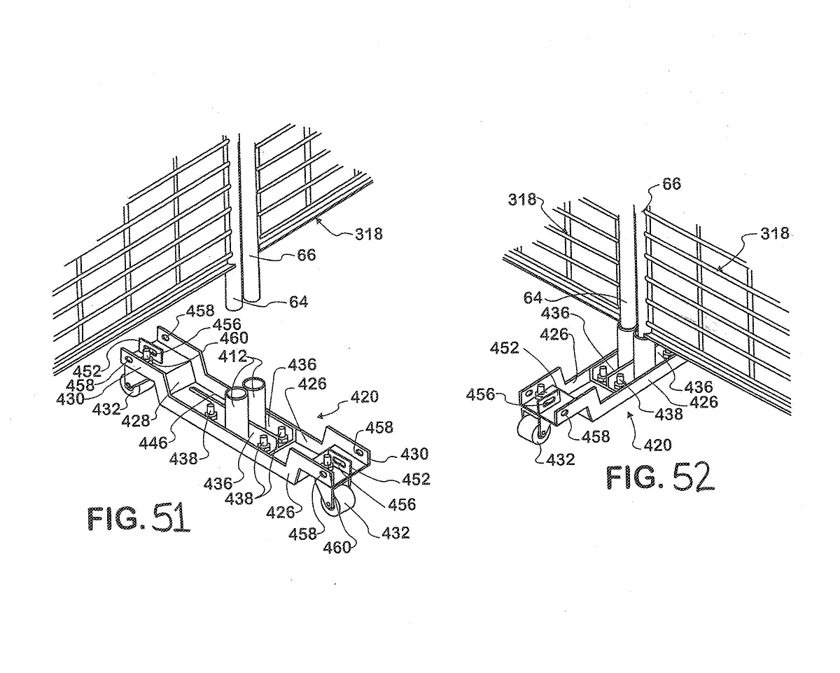

FIG. 50 to FIG. 53, show how the link 312 with its projections 322 can be assembled into the socket 324 of the inserts 314 and held in the ends of adjacent top ends 330 of tubes 316, by the retaining cross pin 332. While the cross pin is used, other type of means could be used such as other pins, say square in cross section (see FIG. 60), fasteners, adhesives, epoxy or brazing, welding, etc.

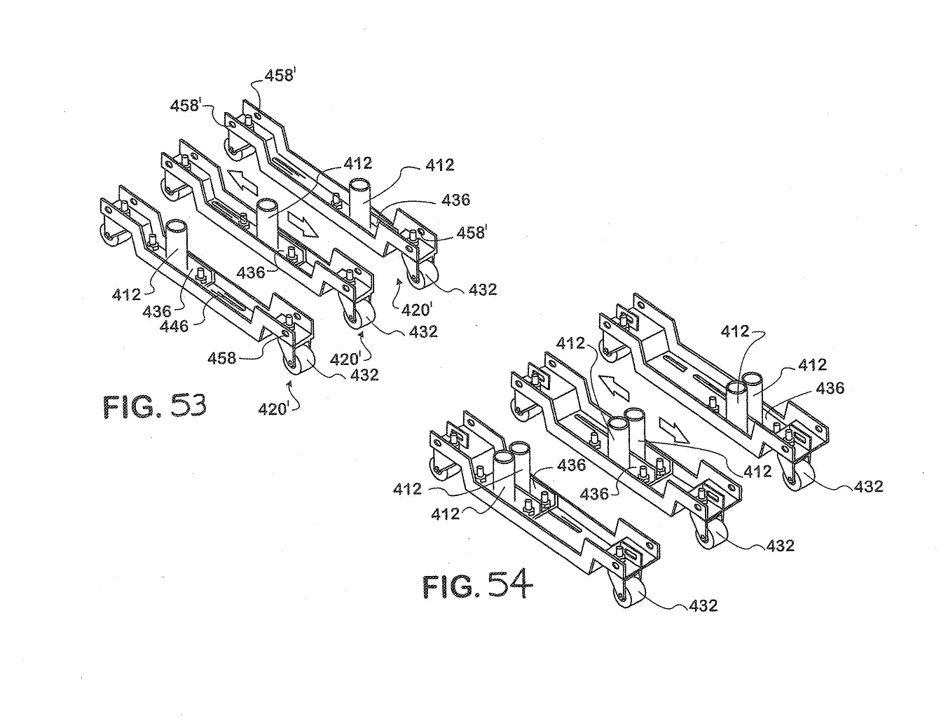

FIG. 54 to FIG. 57 show the two panels 318 held in various angular positions by the hinge coupler 310 of the present invention. The panels 318 are in about a 90 degree apart position in FIG. 54; in about a 145 degree apart position in FIG. 55; in about a 167.5 degree apart position in FIG. 56; and in a linear, 180 degree apart position in FIG. 57. Note in FIG. 54 to FIG. 57, the fasteners 336 have not yet been installed.

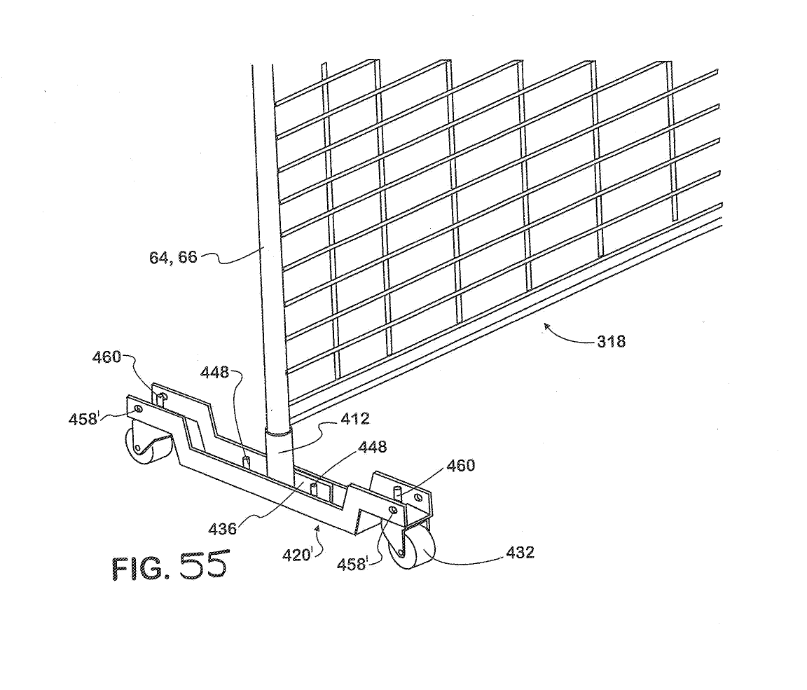

FIG. 58 shows an embodiment identical to that in FIG. 39, except that the fasteners 336 have handles knobs 336A thereon so that they can be installed and removed manually, without the need of tools. The knobs 336A could be integral with the fasteners 336 or could be attached thereto as by welding, adhesive, epoxy, etc. The knobs could be of the same material as the fasteners 336 or made of a different metal or plastic. Also note the lower threaded end of the fasteners 336 could be pointed 336B to more easily locate its threaded opening.

As presented below, prime numbers are used to indicate similar, but not identical parts, for example, tube 316 could be shown as 316′ or 316″, wherein it has some small variations from tube 316.

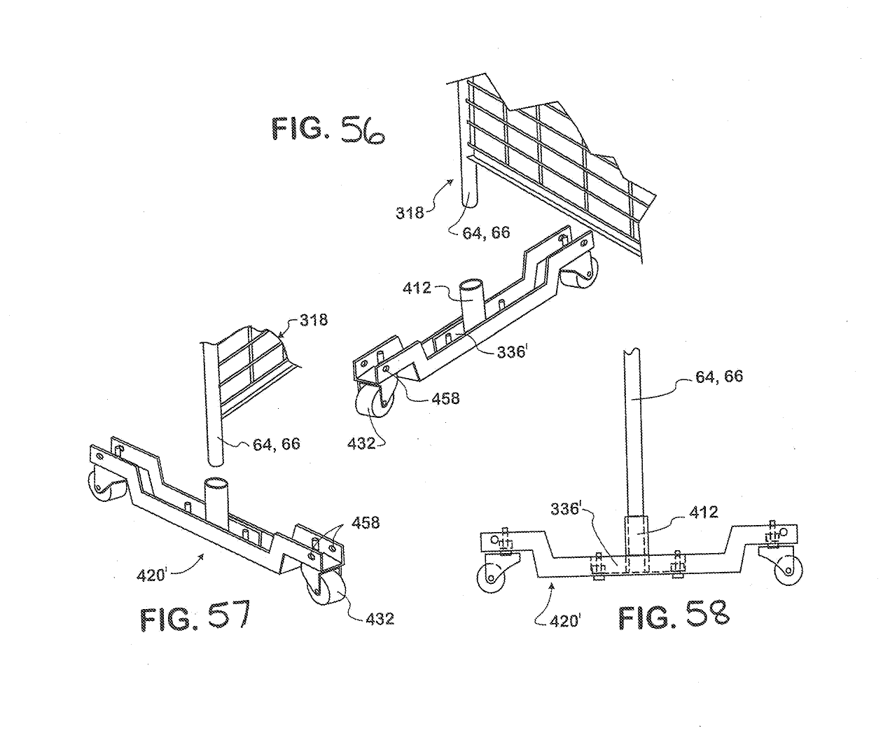

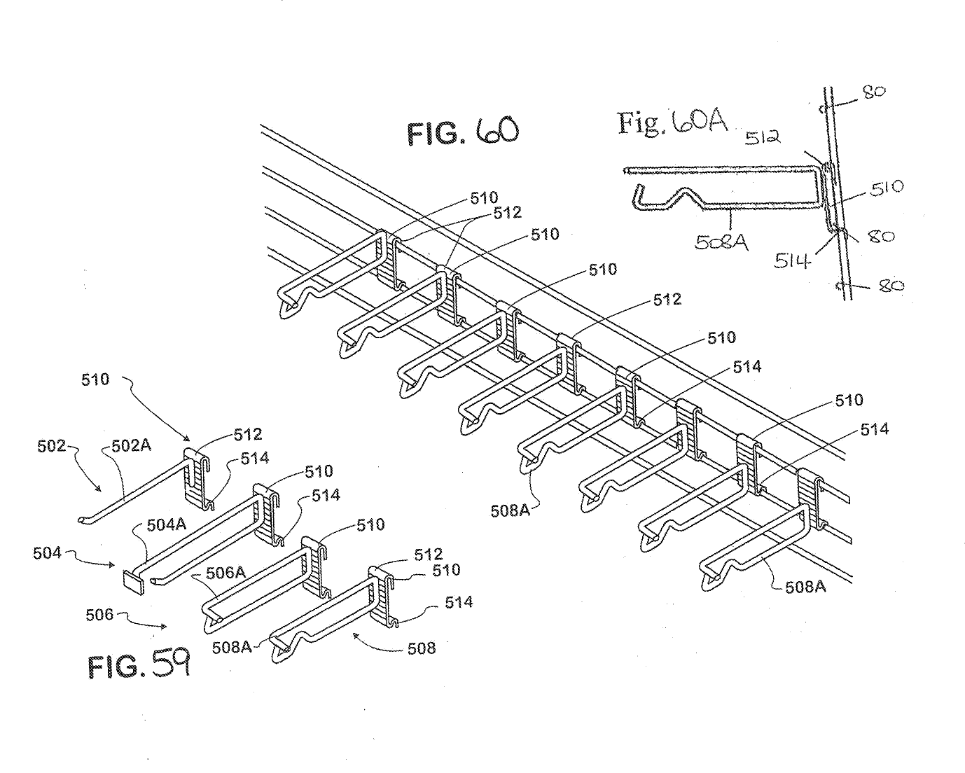

FIG. 59 shows a variation wherein the socket 324′ is formed directly in the end 330′ of the tube 316′. An opening 332A is provided for a cross pin 332. The socket 324′ could be formed by punching or swaging the end of the tube in a die. The socket 324′ is thus formed and could be used in a similar manner as shown or described.

As noted in FIG. 60, the cross pin 332″ has a threaded opening or hole 334A″ which can be indexed, such as both being partially or fully non-circular, in this instance, square to hold the threaded opening 334″ properly oriented to receive the pointed end 336B of the fasteners 336. The opening 332A″ in the ends 330″ of tubes 316″ are also square or non-circular to accommodate the cross pin 332″. Note, also the sockets 314″ have complimentary openings 332B″ to receive the square cross pin 332″. Similar non-circular openings could be provided in the tube wherein the socket is integrally formed as in FIG. 60.

For advertising purposes a third hole or opening 339 is provided in the link 312, at its center and between the two openings 338 to which advertising, such as a banner on posts may be secured.

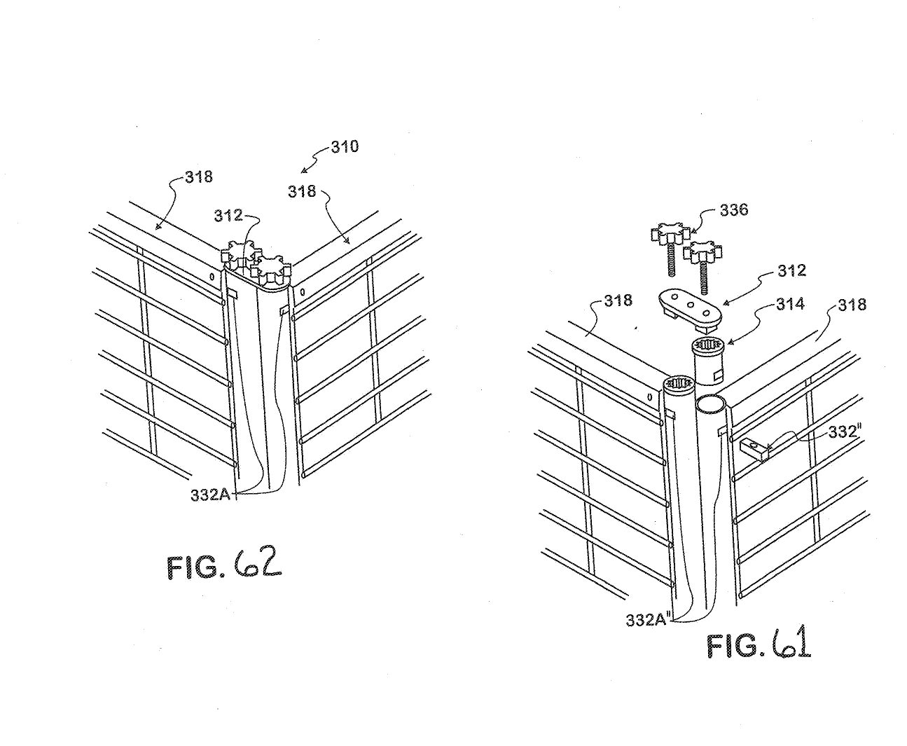

FIG. 61A-C shows a mid-section panel assembly of two panels 318 held perpendicular (end-to-middle) with a coupler assembly 410 and handled fastener 336. The end panel 402 has a shorter width of about 26 inches (26½ inches) and multiple, three, upper connection square holes or opening 404 to receive one of the male projections 322 of the coupler 312.

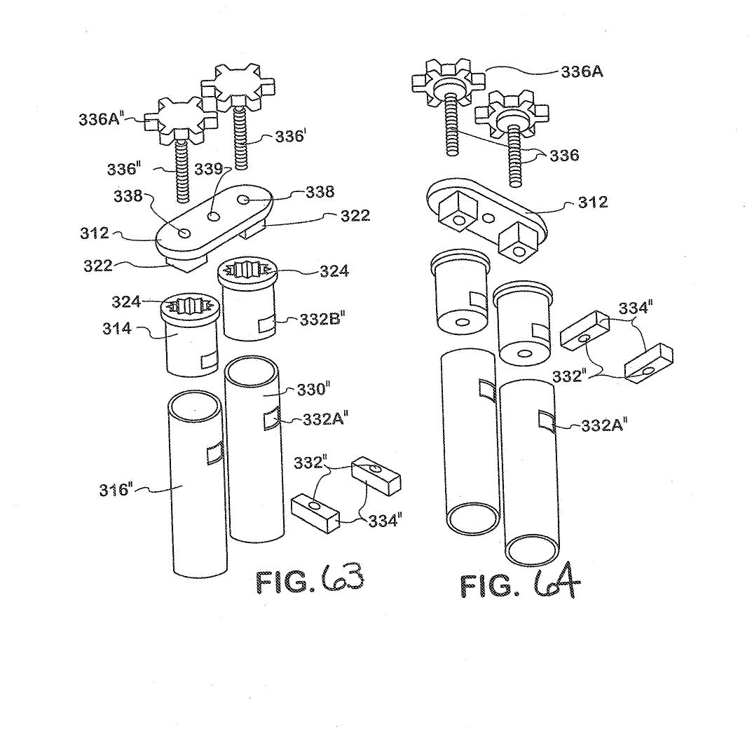

FIGS. 62A and B shows assembly detail of the two connected panel or grids 318 to a double foot or leg 420. As shown in FIG. 62A the leg or foot 420 has two stepped sides 426 extending from a stepped bottom 428. The high ends 430 thus formed mount casters 432 at and under each end 430. In the center low portions are two separate upstanding tubes 412, into, or alternatively over, which the lower portions of the frame posts 64 and 66 can extend. These two tubes 412 are individually secured as by welding to two separate bottom saddle plates 436, which can be individually slided along the center of bottom 428. Of course, if desired, the two tubes 412 could be carried on one bottom plate 436′ so that they moved together, rather than individually and/or separately. The bottom 428 also has two sets long slots 426, one set on each side which can accommodate bolts and nuts fasteners 448 to secure the bottom plates 410 and thus tubes 412 in various positions along the slots 446 to individually vary the position of the tubes 412 and hence the posts 64 and 66 of the frames or panels 318 relative to the ground the panels, and the legs 420. The range of adjustment for this double leg or foot is shown in FIG. 63B. It should be understood that also one tube 412 could be forward and the other rearward of each other. At the ends 430 of each foot or leg 420 is a center vertical tab 452 with a center opening 456, which works in conjunction with collinear opening 458 in the ends of walls 426 to cooperate with other fasteners as will later be later described. The casters 432 can be held by the extended portion 460 onto the leg bottom.

FIG. 63A shows single tube caster foot assembly 420′. The single foot (one tube 412) assembly 420′, is similar to the just described double foot assembly 420. However, assembly 420′ is narrower in width as it needs only to accommodate one tube 412 and one frame post 64 or 66. Otherwise it is similar having the sliding bottom saddle 436 to which the tube 412 is mounted and may be adjusted along similar slots 446′ and held in place by fasteners 448. The saddle bottom for the single leg and the single leg could be sized the same as one of the saddle bottom used in the double legs. The sides 426′ are similarly stepped high at the ends and low in the center, preferably the tubes 412 can be secured, as by being welded, to the bottom saddles 436. Note this is the same part for the double foot. The parts forming these legs can be bent from sheet metal, and like many of the parts here shown in the application could be made of aluminum, stainless steel, and preferably steel, which can be painted as powder coated. FIG. 63B shows similar adjustability up and down the legs length for the double foot assembly as the two saddle bottoms 436 are separate from each other, each tube 412 could be independently adjusted from each other.

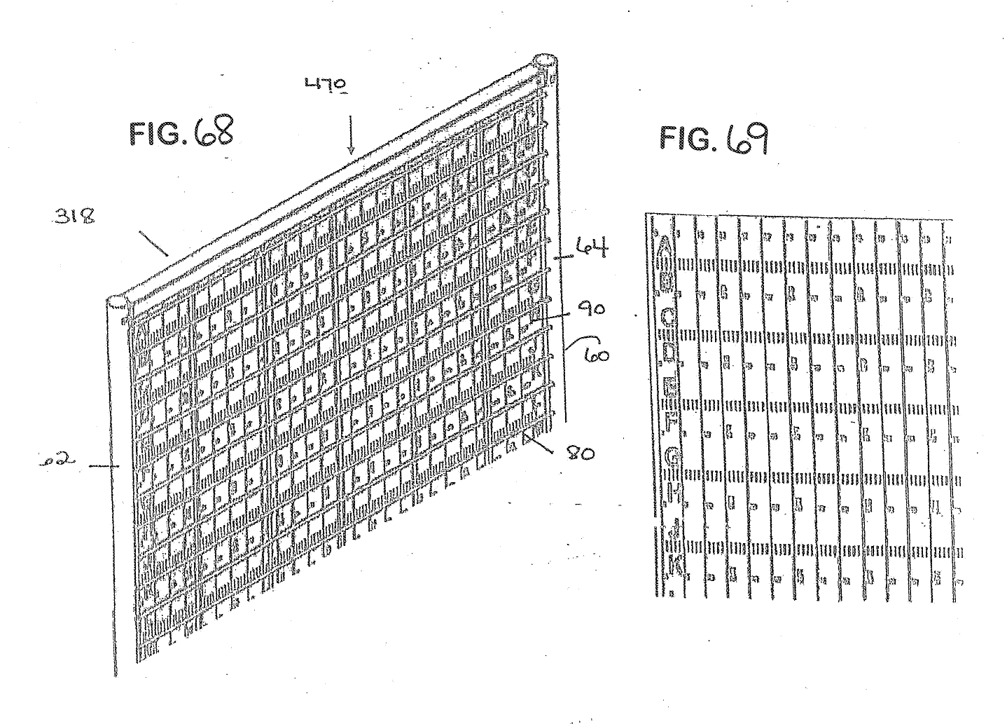

FIG. 64 and FIG. 65A-C shows assembly detail of the panel grid 420′ mounted at one end to a single foot or leg 420′ with two roller casters 432. The single leg or foot 420′ like the double leg or foot 420, has its tube 412 secured as by welding to the interior bottom saddle 436′, which fits on the bottom of the leg and can be slid there along to adjust the relative position of the tube 412. The bottom plate 436′ can be bolted in place in various positions by fasteners 418 which slide in slots 446′ formed in the bottom center of the leg. If desired the fasteners could use thumb screw or wing nuts or other fasteners with knobs or other manual means to tighten them so no tools are needed to make the adjustment. The adjustment in the single or double legs lets the supported panel be centered or biased to one end or side or the other of the leg.

FIG. 66A shows four distinct type product display hooks 502, 504, 506 and 508 assembled with free hanging clip or mounting brackets 510. The product holding portions (left portion) of hooks 502, 504, 506A and 508A, shown in FIG. 66A, are generally conventional, but each is attached as by welding or spot welding to a spring clip (right portion) 510 made or bent to engage the horizontal wires of 80 of the panel grid. See FIGS. 66B and 66C. As shown in FIG. 66B the attachment of the left portion of any of these can be relatively altered with respect to its position and particularly height, on the spring clip. For example, if the grid wires are spaced apart 2″, the set or series of brackets shown in FIG. 66B could differ in relative height of the joint by say ¼ inch so that by using different ones of the hooks the desired product spacing on the display can be achieved. To hold the spring clip portion 510 to the grid wire 80, the clip has an upper hook 512 which fits over an upper grid wire 80 and a lower snap hook 514 which snaps onto the lower grid wire 80 to secure the clip and product hook be it any of 502A, 504A, 506A or 508A or other type to the grid. The display hooks are spot welded to the mounting bracket in eight vertical positions (sets of eight being provided for each hook style.)

FIGS. 67A and B is similar to FIG. 58, but here shows an assembly of two perpendicular panels 318 to form a corner with coupler assembly 310 like that shown in FIG. 58.

Like the coupling assembly shown in FIG. 60, the cross pin 332″ in FIGS. 67 A and B is square in cross section and fits into square openings formed in the frame post or tube and socket so as to index them relative one another and to index the threaded opening in the cross pin to receive the fastener.

FIGS. 68A-C are schematics (with FIG. 68A being a cross section) of the details of the coupler shown in FIGS. 60 and 67A and B.

FIG. 69A-C are schematics (with FIG. 69A being a cross section) for an alternate using a socket 424 having a plurality of segments 428 (here six), which can be pulled by the fastener 336 into tight friction engagement with the interior of the tube 464 or 466 to hold female socket portion 428, of the socket and hence, the male portion 312 of the coupler 312 in place in the tubes 462 and 464. As the screw 336 is tightened, it pulls the bottom 465 of the socket 424 upward, which in turn forces the sidewalls 428 outward to tighten against the interior of the tube. To keep the sockets indexed or aligned as desired, they have alignment slots 468 which receive alignment indents 472 formed on the tube. Of course, if desired, the placement of these alignment slot and indent could be reversed on the tube and socket. The cap 312 of the coupler is the same or previously shown in FIG. 60.

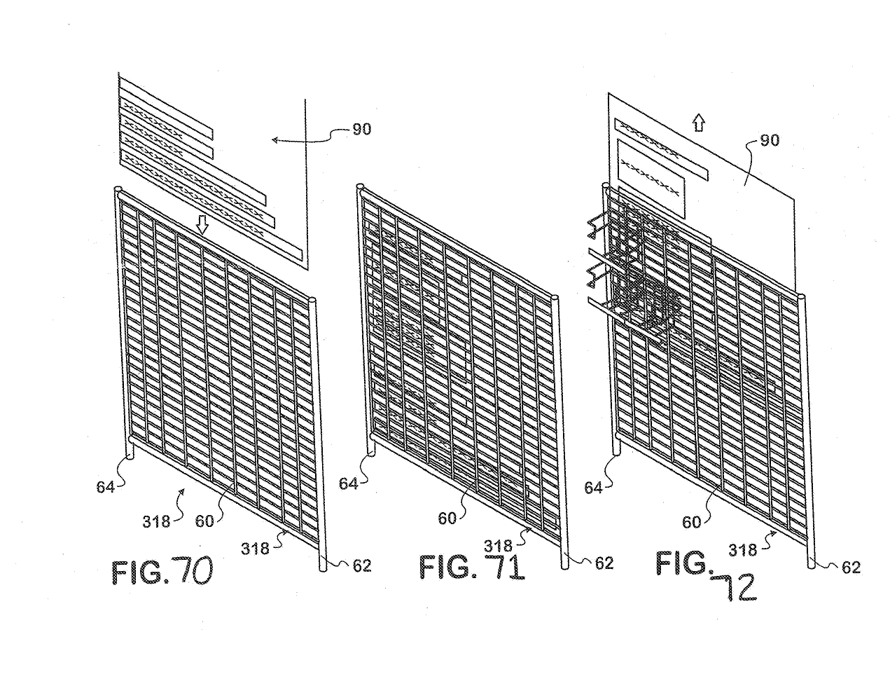

FIG. 70A shows a panel with its frame 318 formed by vertical posts 62 and 64 and carrying on either side of a grid 60 with a gap, space or slot there between. A plan-o-form or product placement or locator board (really a flexible sheet) 90 that carries rows and columns to specify product placement, etc. can be inserted. Alternatively, this board or sheet could show product outlines on the board for the same purpose. As shown the space into which the board is located can be closed by a removable panel cap 47—see FIGS. 93A and B. As noted, the cap can be removed, the locator inserted into the slot between the two grills, and when the panel is set up with products, the locator can be removed and the cap 470 put back in place to close the gap or slot. This assembly of product brackets, etc. just described is illustrated in FIGS. 71 A, B and C with the heavy arrows indicating the install (FIG. 71A) and removal (FIG. 71C).

FIGS. 72A to D show another type product display 500, including a component bracket 502 which can be secured to the grid wires 80 and also carry various forms of product display devices, such as the shelf shown. The bracket has two upper hooks 504 which can be hung from a horizontal grid wire 80. It also has a set of center hooks 506 and another set of lower hooks 508. With the bracket having six hooks engaged on the grid on three separate wires (FIG. 72D), the bracket can carry a considerable load per bracket. Should greater capacity be needed, several component brackets could be used to carry a single device.

As shown in FIGS. 72B and C the bracket can have, for example, a shelf hung on it with the base of the shelf engaging an upper outer hooks 506 on the bracket 502. A pin 510 can be placed over the hook 512 into an opening in the bracket to trap of the shelf wire 514. The bottom wire of the shelf bears against the bracket 502 to hold the shelf. The bracket itself can be pinned with pin 518 at the bottom below one of the grid wires 80 to prevent lifting the bracket 500 upward.

To prevent sliding of the metal bracket hooks on the upper grid wire, two rubber pins 520 are inserted into the bottom of the center openings in the upper hooks. The rubber pins 520 provide enough friction to prevent sliding of the bracket.

To assist during set up of the component bracket a plastic grid clip 522 can be inserted to trap a grid wire 80 when it was snapped into the square hole 524 in the bottom of the component bracket. The hanging of the bracket on the upper grid wire 80 on the bracket hook and the use of the plastic grip clip on the lower wire is enough to prevent the bracket from moving around until fully set up.

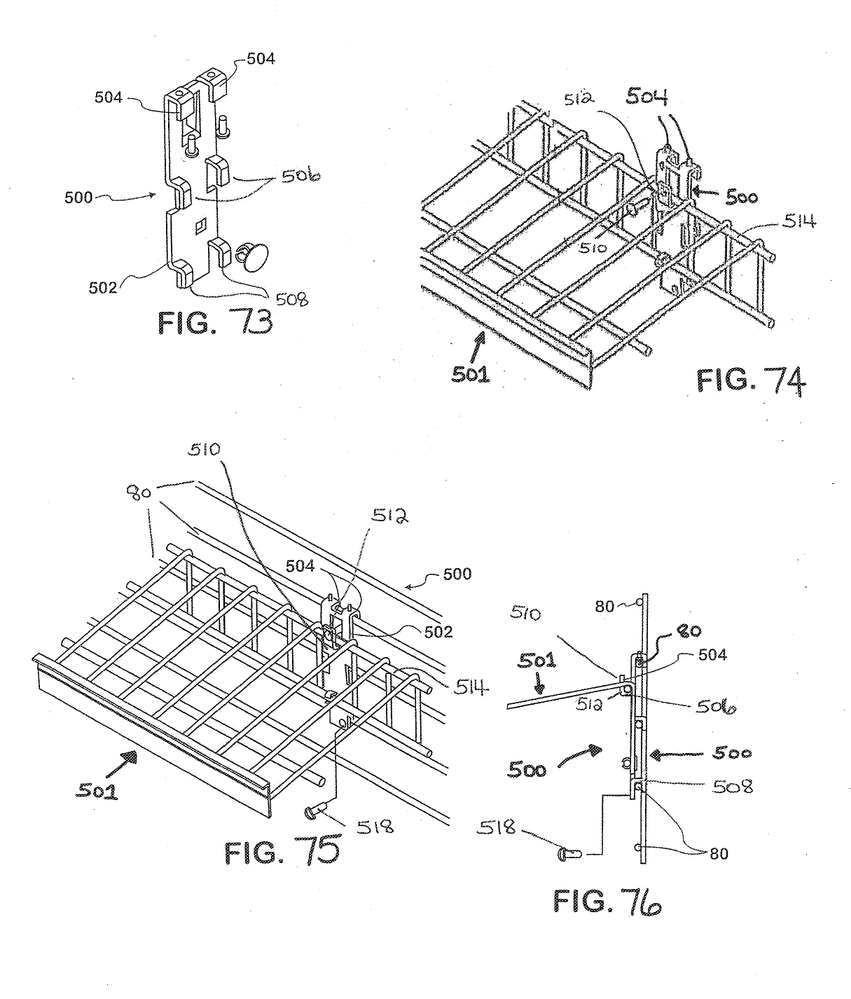

As shown in FIG. 73, the component bracket 502 can be made in a variation wherein the product bracket's hook 512 is varied, by say ⅛ inch or other steps, so that the product can be displayed with the desired relative position with respect to the bracket and hence grid.

FIGS. 74A to C, illustrated how a end panel 530, such as a register panel, used at or near a register, can be placed on and perpendicular to a panel 318, which, in this instance, is mounted on a single leg 420′. Of course, if desired, a register panel could be placed on a panel with a double leg 420. To do so a bottom mount 532 is secured to the leg, and the end panel bottom 534 held on the bottom mount 532. To assist the bottom mount 532 has a bottom opening channel 536 which receives the raised end portions 538 of the leg or foot, and the bottom 534 of the end or register panel fits into an upward facing channel 540 of the bottom mount 536. As shown in FIG. 74C a grill constructed end panel 542 could be used instead of a solid panel 530.

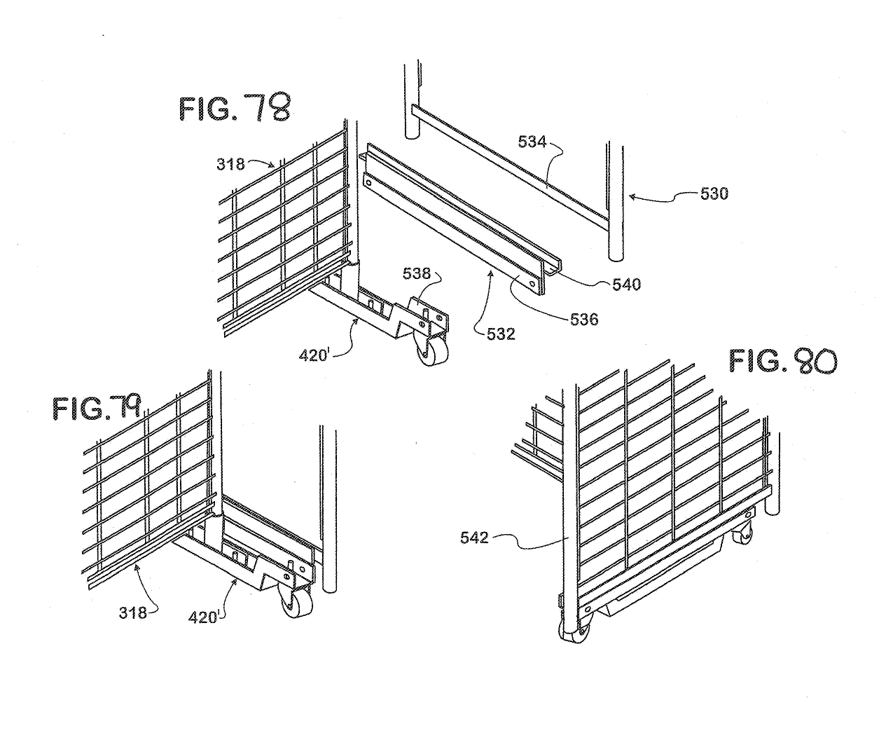

The upper end of the end panel is held as shown in FIG. 78. As the upper mount 550 is provided with these square opening 552 in its top 554 to receive the male portion 322 to provide three positions, the bottom channel too can by sliding along the leg accommodate any of the three upper positions.

FIGS. 75A to C show another form of fixed hook 560 which is attached, in this instance, to a shelf 562 to hang the same off the grid wires 80. The hook has a cooperating lower protrusion to help trap the wire 80. As shown in FIG. 75C, the hook bracket can engage on various wires 80 to provide height variation.

FIGS. 76A to D illustrate how a peg board type display 570 can be attached to the grid via hooks 572 on the back side of the peg board. These hooks 572 can be carried on vertical support 524 s on the pegboard.

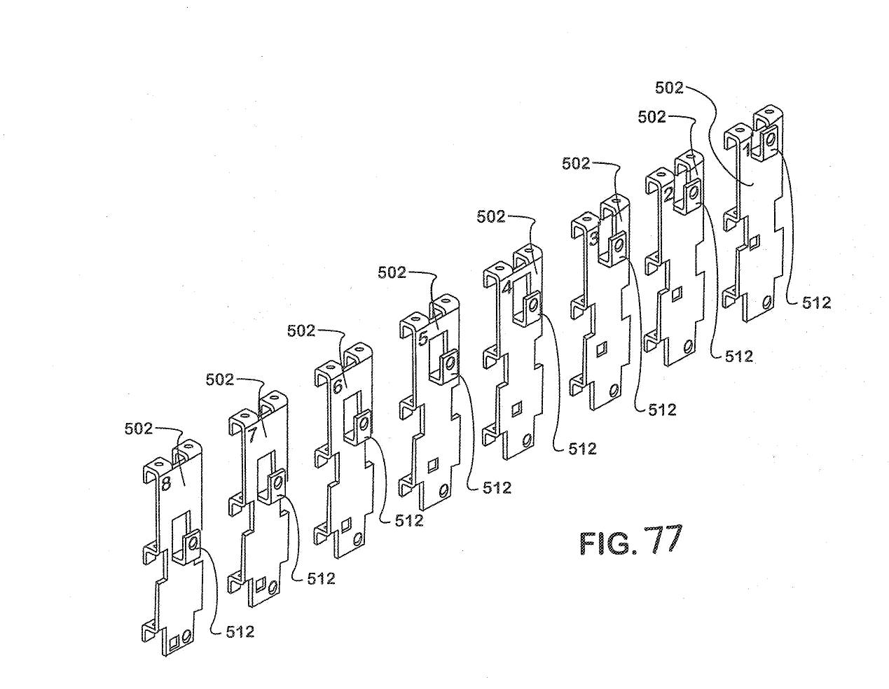

FIGS. 77A to C, illustrate how a divider 580 having plural hooks 582 thereon can be attached mid panel, with the hooks 582 engaging the wires 80 of the grid. Several of the multiple hooks can be located along the height of the divider.

FIGS. 78A to C show how the top of a register or end panel 530 can be attached perpendicularly to a panel 318. FIGS. 79A to C show the bottom of the register panel 530 can be attached to the panel and its leg 420′ using the bottom mount 532 previously disclosed and described in FIG. 74A-C.

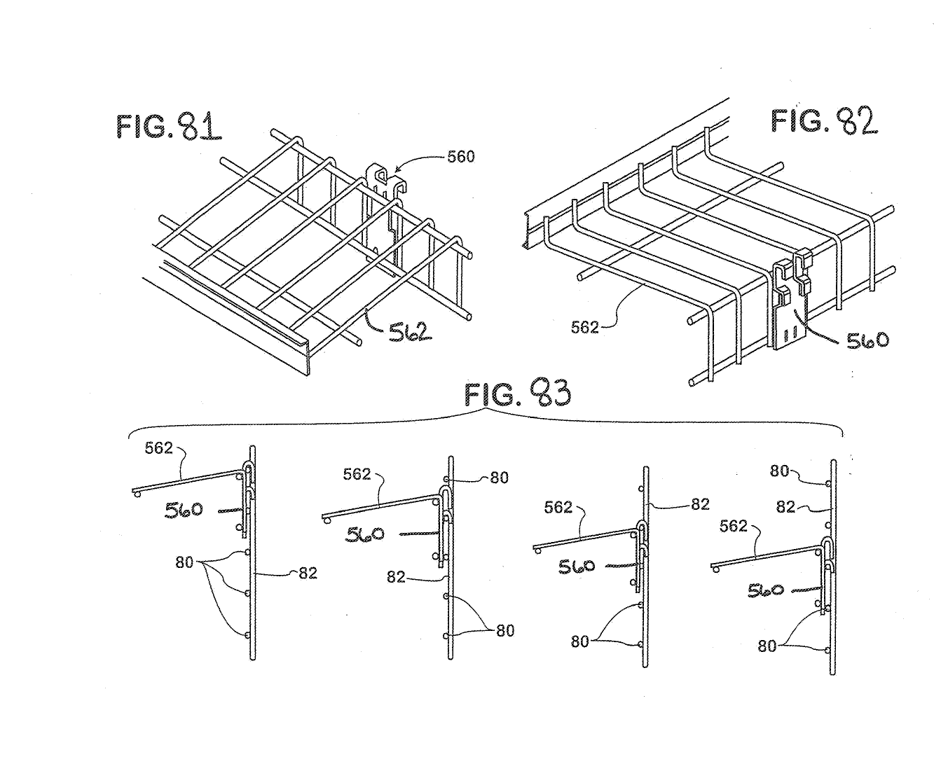

FIG. 80 shows two register panels 630 attached at the top and bottom in a manner just described, but this time to a split panel 632 having an offset top 634 and bottom 636 with a shelf 638 formed there between, and mounted or a pair of legs.

FIGS. 81A and B show how a top extension 570 can be added using an extension panel 572 having lower posts 574 fitting into the tops of the posts 64 and 66 of a panel 318. If the extension is to be joined to another adjacent post and panel a coupler 310 is provided and held connected in place by an upper cross pin 332D with an enlarged non threaded opening 332E to permit a long fastener 336C to pass through. The longer knob 336C fastener fits through the upper cross pin 332D to engage the lower, threaded cross pin 332F in the normal manner to hold all parts together. The extension can have the same or different grid. Here, the extension grid 576 shown is more closely spaced vertically say one, instead of two, inches between grid wires.

FIGS. 82A and B illustrate that a cooler, freezer or refrigerator 590 can be mounted to a panel and its leg. To secure the cooler 590, a top ring assembly 592 is secured to the refrigerator 590 and then connected to the panel 318 and its vertical end tube 62 using upper cooler brackets 591. The bottom 594 of the refrigerator is attached to bottom cooler brackets 596, which in turn are connected to the panel leg 420′ using a cooler. The door 600 of the refrigerator is at the side (front) opposite the panel 318.

FIGS. 83A and B show a cooler, refrigerator or freezer or both using a cooler 590 having its back 590 attachment 593 attached to the panel in a similar manner using a top ring and lower connector bracket. Here the door 600 of the refrigerator is perpendicular to the panel 318.

FIGS. 84A and B show the cooler attached at its side to a panel.

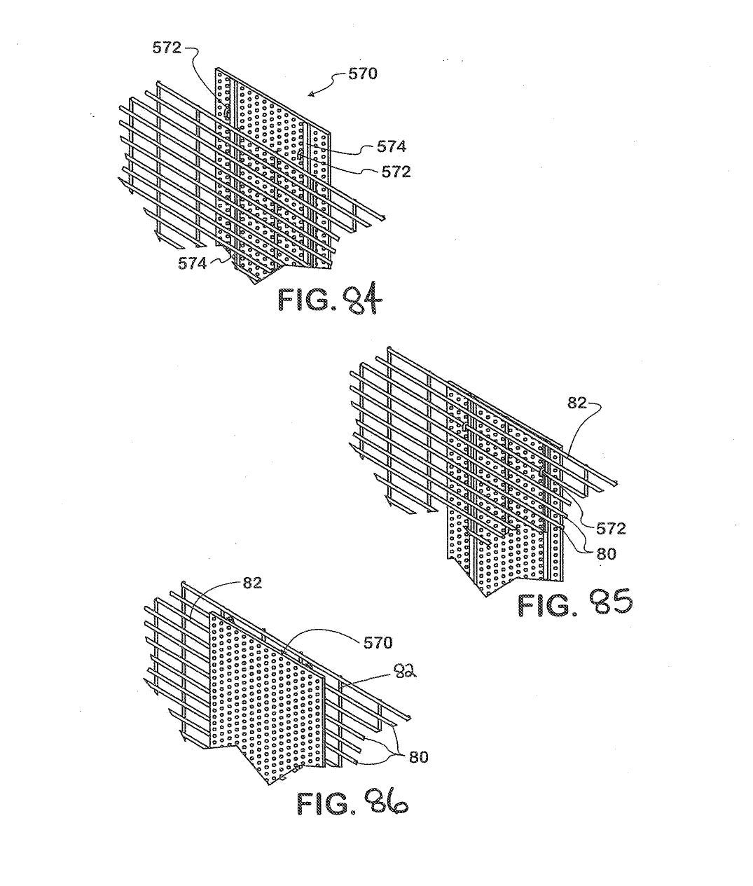

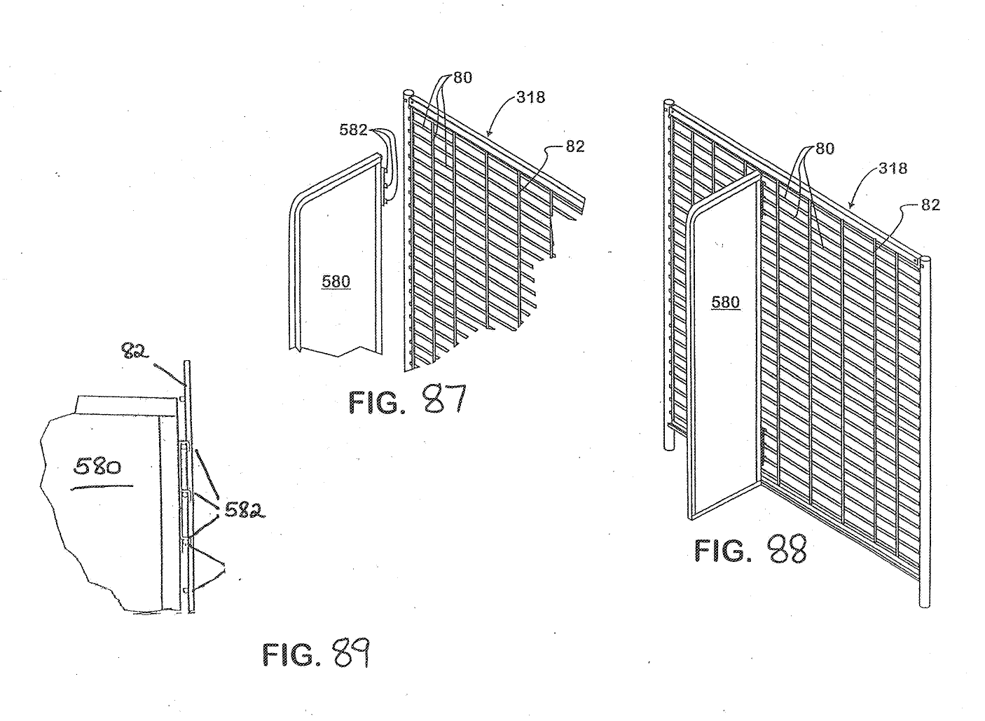

FIGS. 85A and 85B illustrate the attachment of a surround 630 made up of grill or grids on three side 627, 628, 629. The open side can be at the end (FIG. 84A) or at the side of (FIG. 84B). A refrigerator, cooler or other display could then be placed into the interior 636 of the surround or the surround used for other product display purposes.

FIGS. 86A and B show how the top and bottom respectively of the surround 630 may be mounted to the panel. The connector bracket 640 and raised end of the leg or foot 420′ has openings 642 to accommodate the studs 644 of a double headed snap button 645 to hold the mounting to the sidewall of the leg. The connector bracket has the downward opening channel to accept the raised sidewall of the leg ends. The surround can be bolted to the connector bracket 646. The top 649 of the surround back has a square opening 650 to accept the male portion 322 of the coupler 310 and can threadably receive the fastener 336A. Similar square openings could be provided on the top sides of the surround for alternative side arrangements.

As shown in FIGS. 87A and B, the cooler 596 can be fitted with a cooler top rack 660 which can be mounted by four fasteners 662 to the cooler top ring assembly.

As shown in FIGS. 88A and B, the ends of the legs or feet 420 or 420′ can be connected by bumper rails 680, these of a fixed length. The bumpers have downward extending double wall end tabs 682 which fit over the raised sidewall 683 of the leg or foot 420 or 420′, and both have openings 684 to accept the stud 685 of the double headed snap button 645. The snap bottom is spring loaded outwardly but can be disengaged by hand so the bumper can be installed or removed without tools.

FIGS. 89A and B show how the bumpers of FIGS. 88A and 88B, respectively, will look when installation is completed.

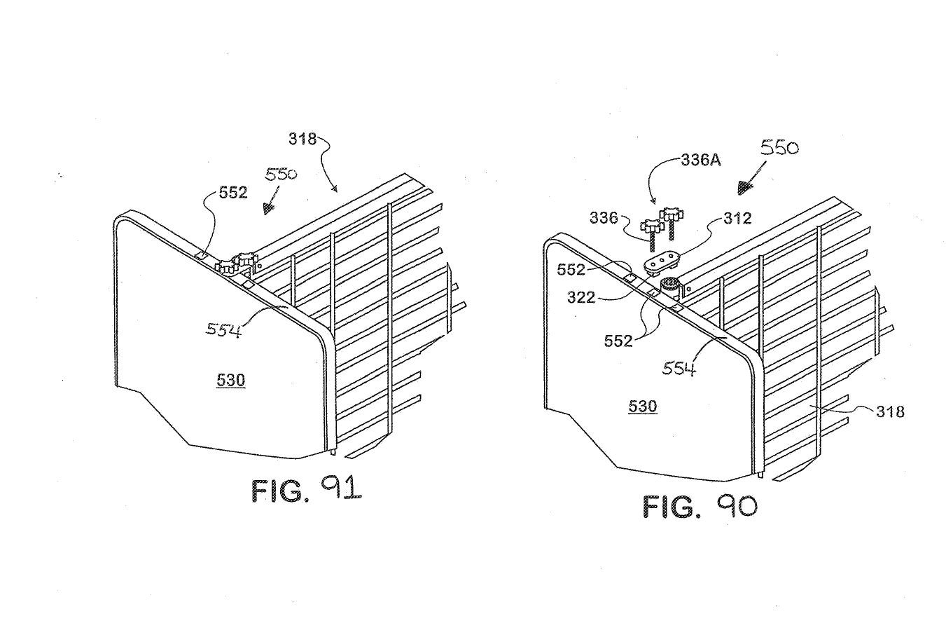

FIG. 90 shows how dust covers for the right 700 and left 702 (singles) corners and the center (doubles) 204 there between can be installed to cover the caster. As shown the dust covers 700, 702 and 704 are snapped over one edge and may have a retainer 706 to hold them in place.

Instead of a fixed length bumper 680, an adjustable length bumper 720 can be provided as shown in FIG. 91. The adjustable bumper 720 comprises inner and outer telescopic tubes 722 and 724 in this instance, of a square cross section. The outer tube 724 has a plurality of openings 726 to receive a spring 728 based snap button 730. See Detail A of FIG. 90. The two ends of the adjustable bumper pivot as shown by the hinge 732 construction at the leg's large end, and the pin hinge 734 construction at the small tube end as shown in Detail B of FIG. 90. Both ends have downward opening channels 738 to receive the raised end sidewall of a leg. In addition, openings are provided therein to receive the studs of the snap buttons to hold the pivotable ends of the adjustable bumper on the leg. As shown in Detail B, the pin hinge has two tabs secured on the channel as by welding, with holes to engage a hinge pin 737 dropped through two openings in the small tube and welded in place and ground flat with the tube surface to form the limited movement joint (say + or −10 degrees).

The large end hinge has the channel 738 welded to a short segment of large size tube to which at the other are one upper and one lower tab. The upper and lower tabs are secured as welded or formed by the tube and have opening for a hinge pin 739. Similar construction is provided on the outer end of the larger tube. The hinge pin is engaged on all four tabs to provide the hinging action.

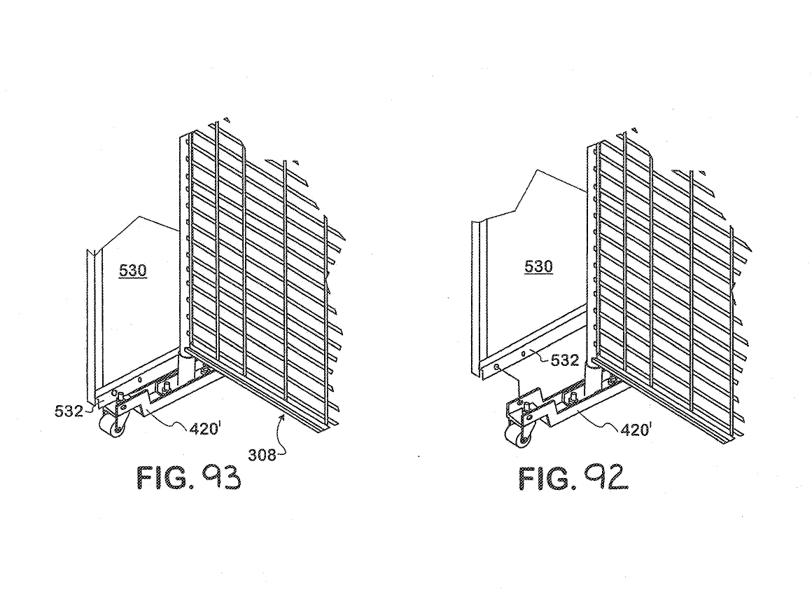

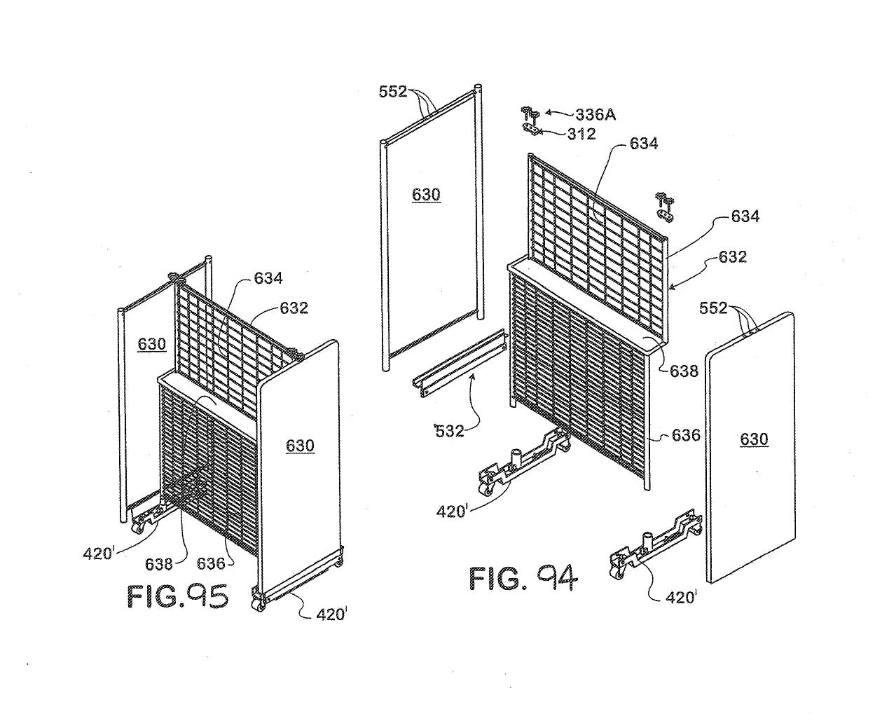

FIG. 92A to C shows how the adjustable bumper 720 may change length and pivot at each end, indicated by the heavy arrows 800, 801 and 802 in FIG. 91C. FIGS. 91A and B show how two panels 318 may be linearly joined to an adjacent panel in a manner described above. The outer end of the legs may also be joined by an adjustable bumper 720, and here two are used, one or each end of the legs on each side of the leftmost panels as shown in FIG. 91A.

As shown there the two panels are linear and the all bumpers 690 and 728 are parallel to each other. Referring now to FIGS. 93A and B leftmost, the end panel may be bent or turned relative to the other panel 368, and as shown, one adjustable bumper 720 can elongate while the other 720 shortens. Thus, though assembled, the panels may still be changed angularly, relatively a limited amount (say about 22.5 degrees) without dissembled and reassembly of the structures. Of course, dust covers like 700, 702 and 704, could also be provided if desired.

It should be understood that the previously referred to software can generate the product lay out or plan-o-form 90, which can be installed or removed from the space or gap 820 between the two grids of a frame or panel as shown in FIGS. 93A and B.

FIGS. 95A to C show portions of another embodiment of coupler 850, which can be used similarly to coupler 10 and 310. This embodiment comprises the same knob 336A with threaded screw fastener 336, coupler link 12 or 312 with male projections 22 or 322 thereon. This male projection 22 or 322 engages with a socket insert 860 that has a series of cutouts 864 on its lower perimeter. Within this socket 860 is a finned nut 866 with fins 865 which fit into the cutouts 864 to prevent rotation of the nut relative to the socket insert. The interior lower center portion of the socket 860 is threaded to accept the fastener 336. When the socket inert 860 is placed in the upper end 876 of the tube 64′ or 66′ and the fastener 336 tightened, the wedge shape of the nut fins 865 spreads apart the lower portion of the socket insert wall to frictionally hold the insert 860 in the tube 64′/66′ and the coupler link 312 and its male projection 322 in the desired, selected relative angular relationship to the female socket points 324 in the upper end of the socket insert 860. The individual nut 866, socket insert 860 and fasteners 336 (there a bolt) are shown in FIGS. 95C. How they are assembled with each other for one side of the coupler is shown in FIG. 95B, but outside of the tube 64′/66′. The tube 64′/66′ has an inward indent 890 which can engage in one of the cutouts 864 to index the socket insert 860 to the tube and prevent the socket insert from turning in the tube when the fastener 366 is turned. FIGS. 96 A, B and C show the installation of a divider 900 onto a pair of panels 319 and the coupler link 312. The divider 900 at the top carries a top divider bracket 904 having two holes 905 to fit under the two fasteners 336. At the bottom the divider has another bottom divider bracket 910 which has a lower “U” shaped portion with openings 904 to be engaged by the same snap buttons 645 used to hold the bumper rails 680 in place. FIG. 96A shows the divider by itself with its brackets. FIG. 96B shows the start of and FIG. 96C shows the completion of the divider installation.

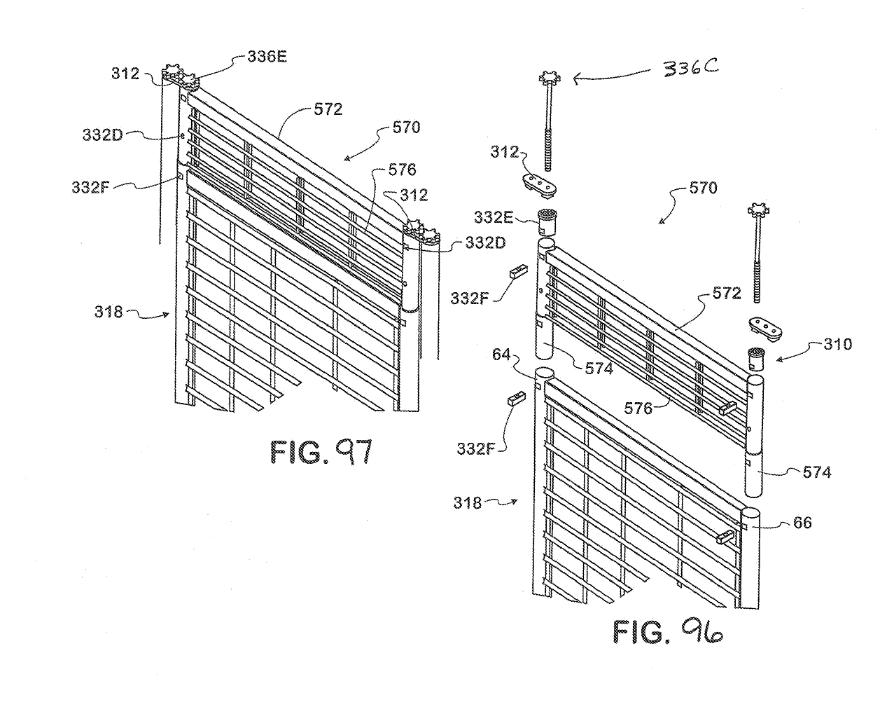

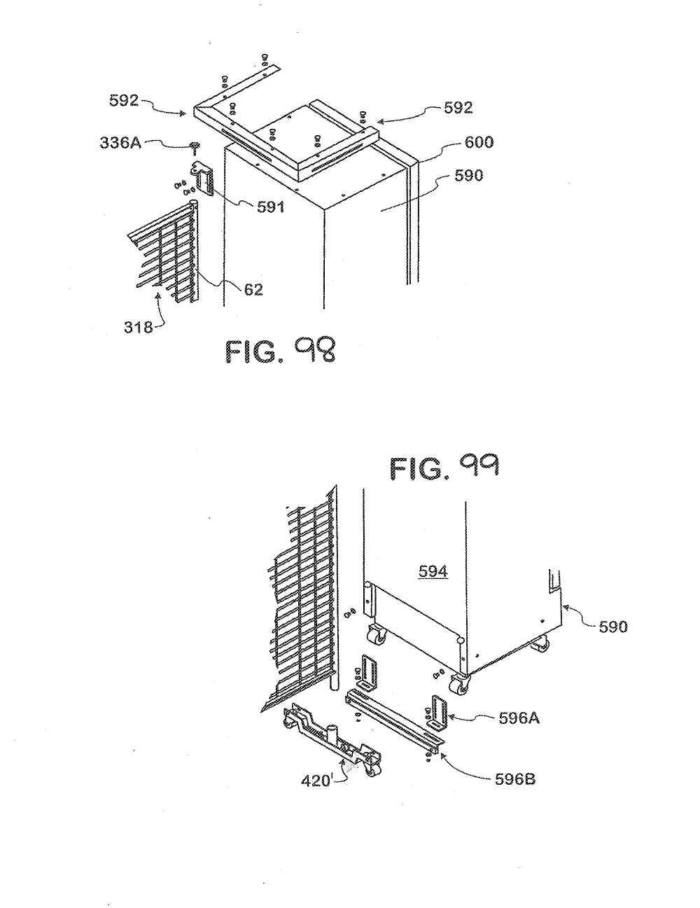

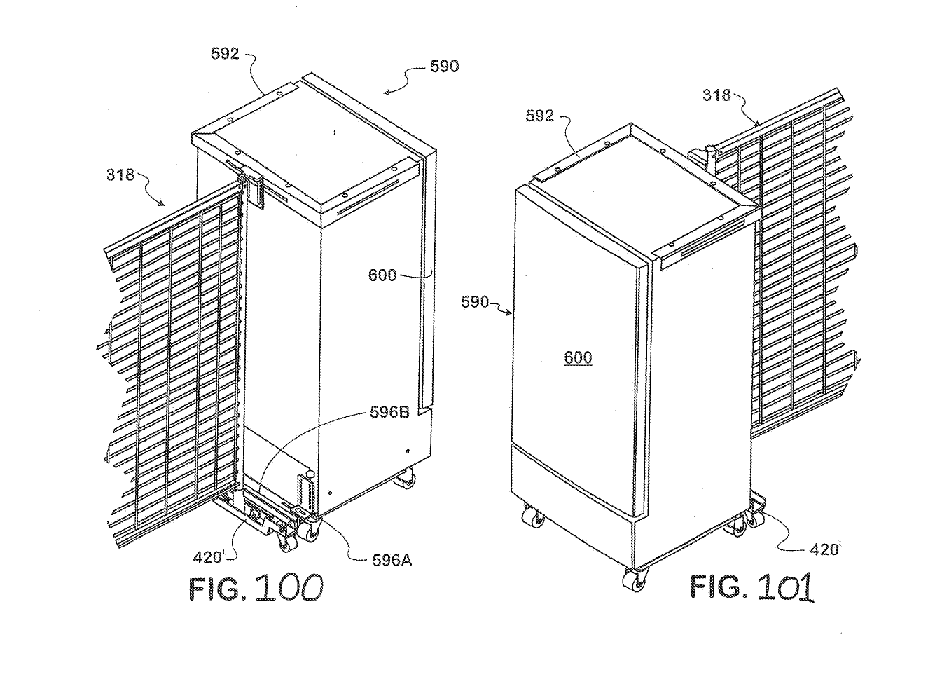

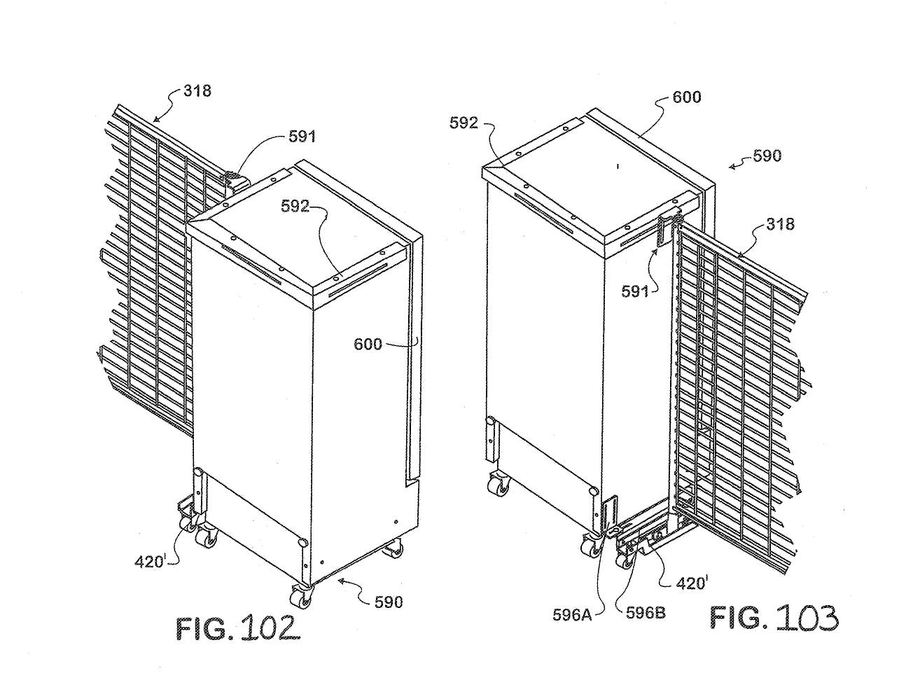

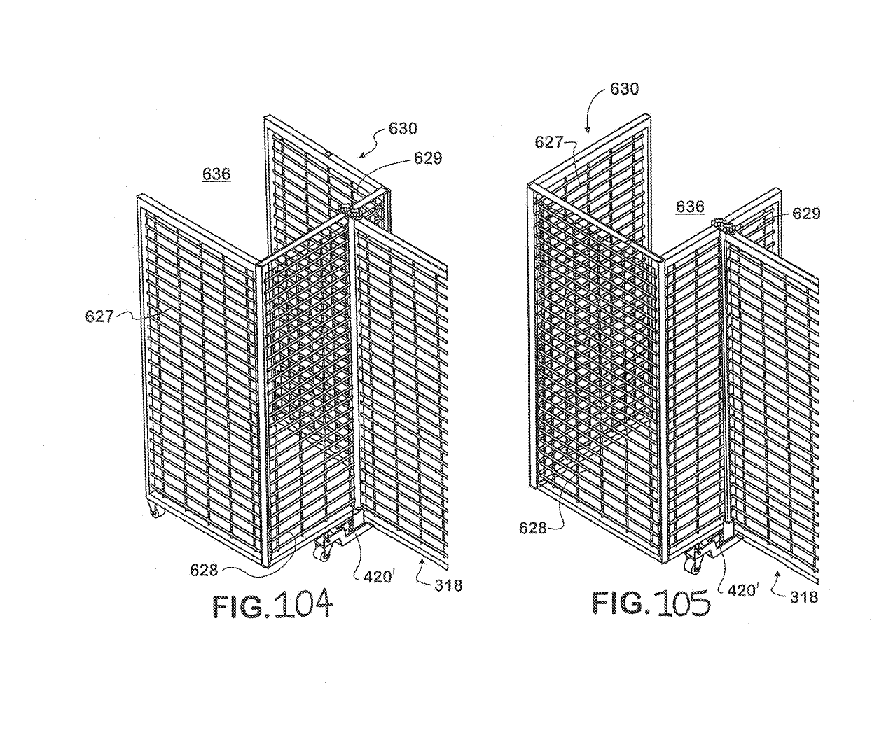

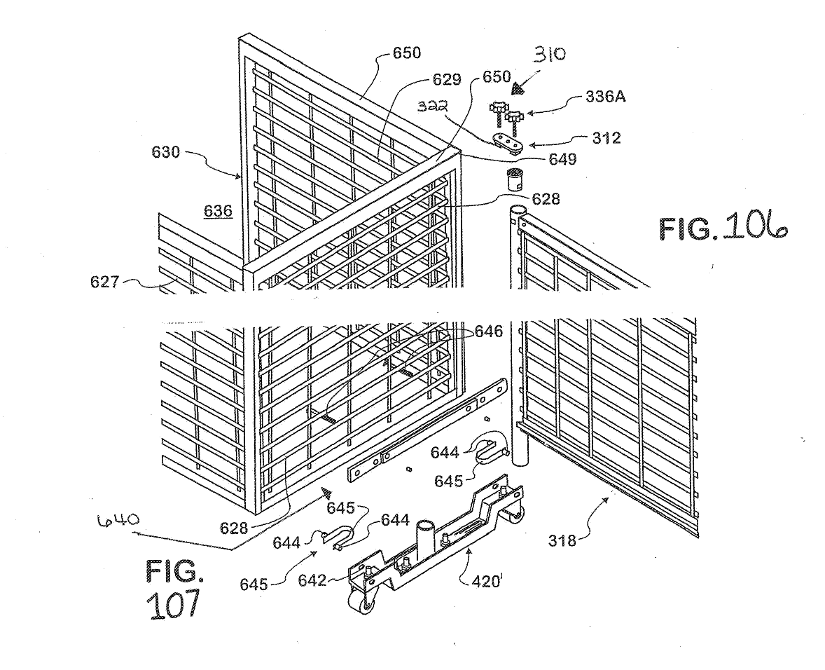

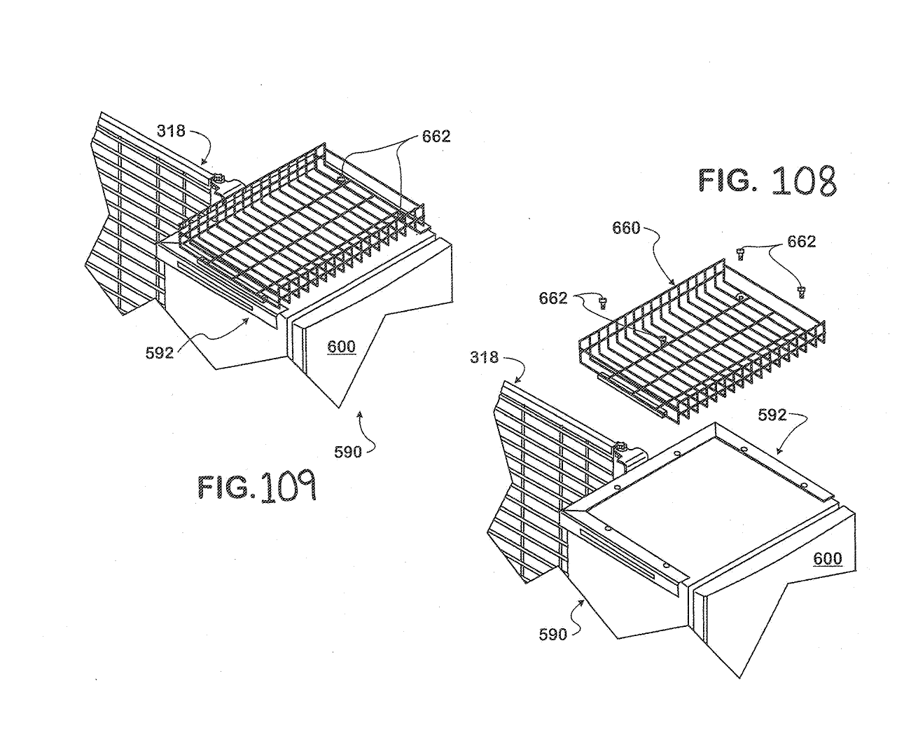

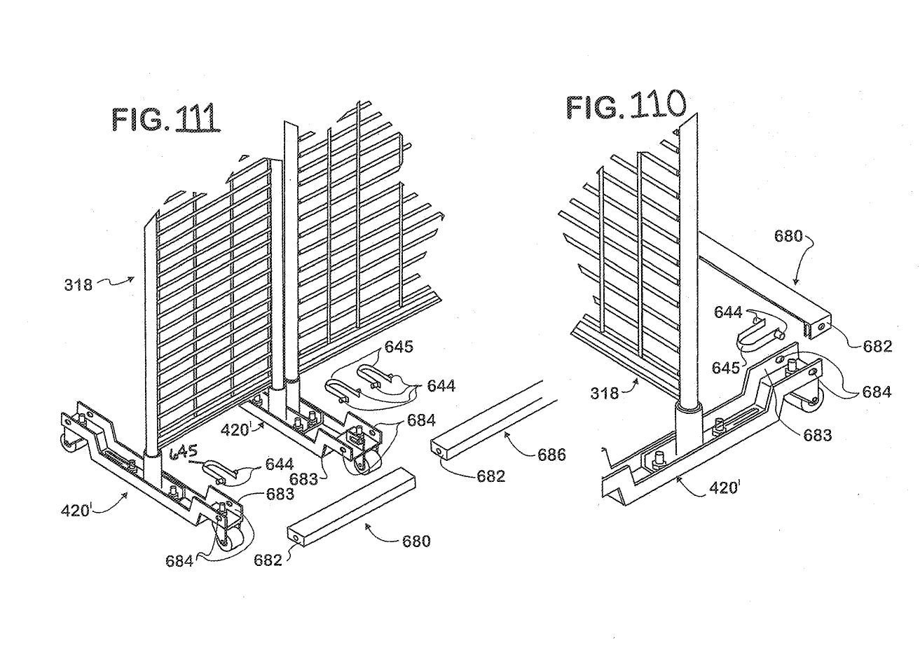

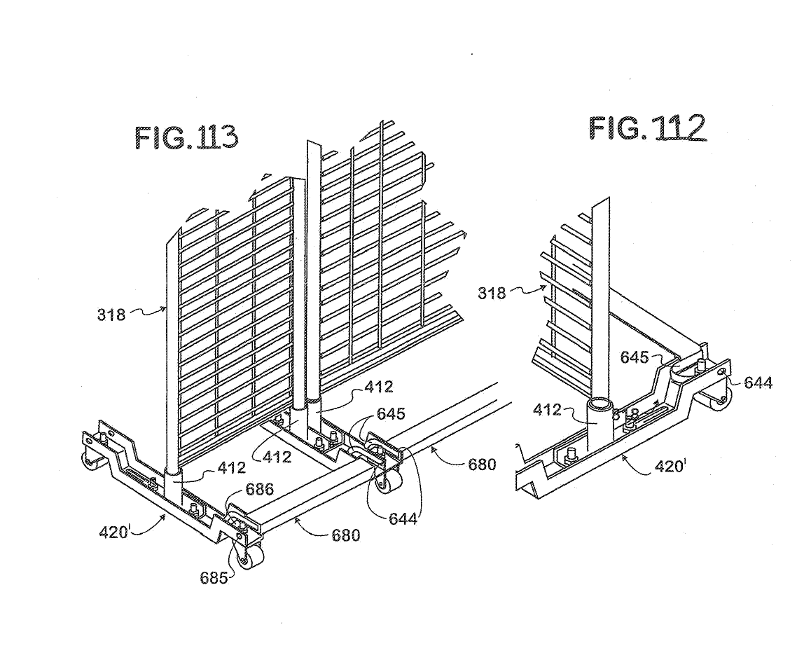

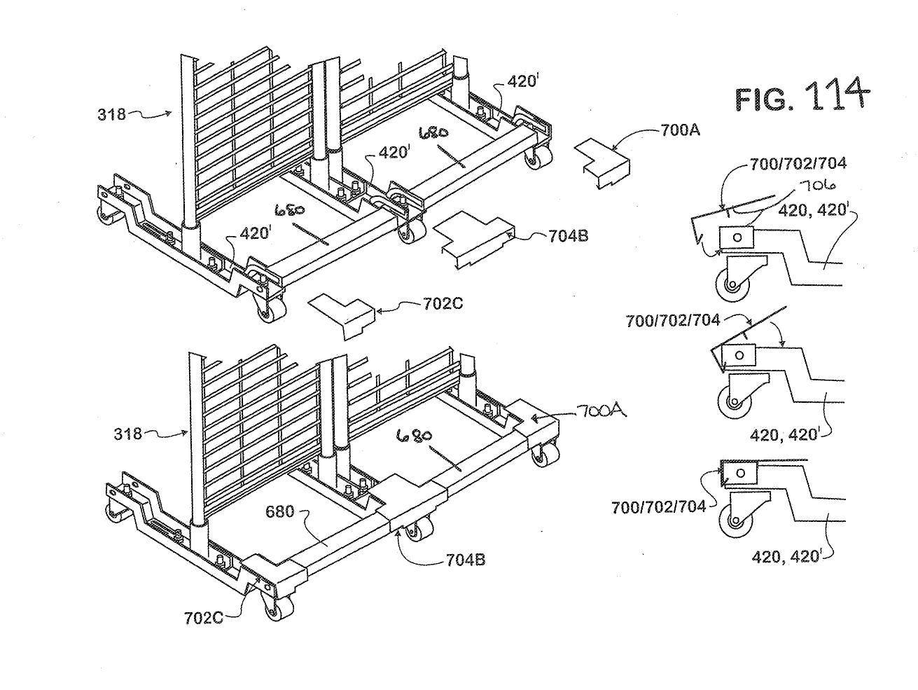

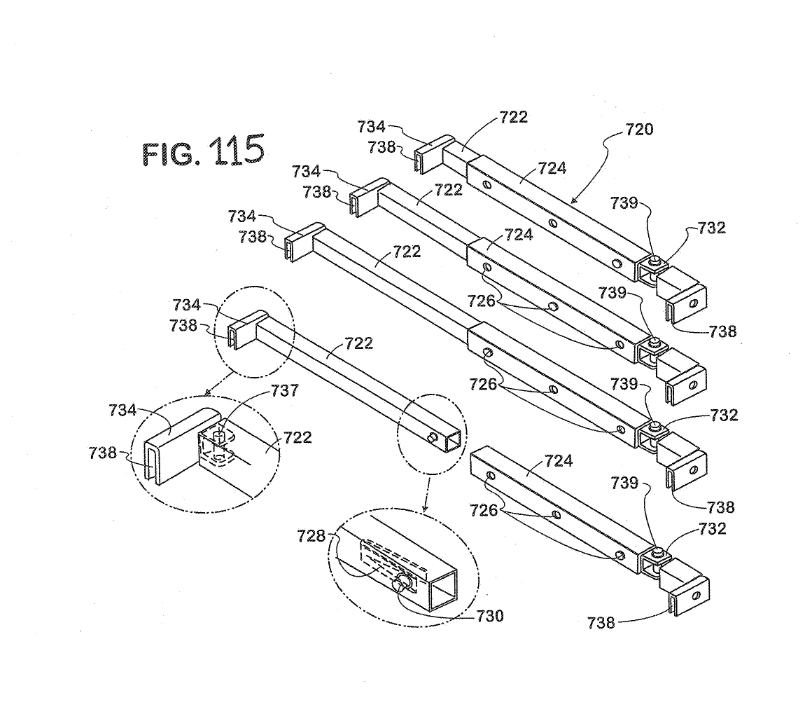

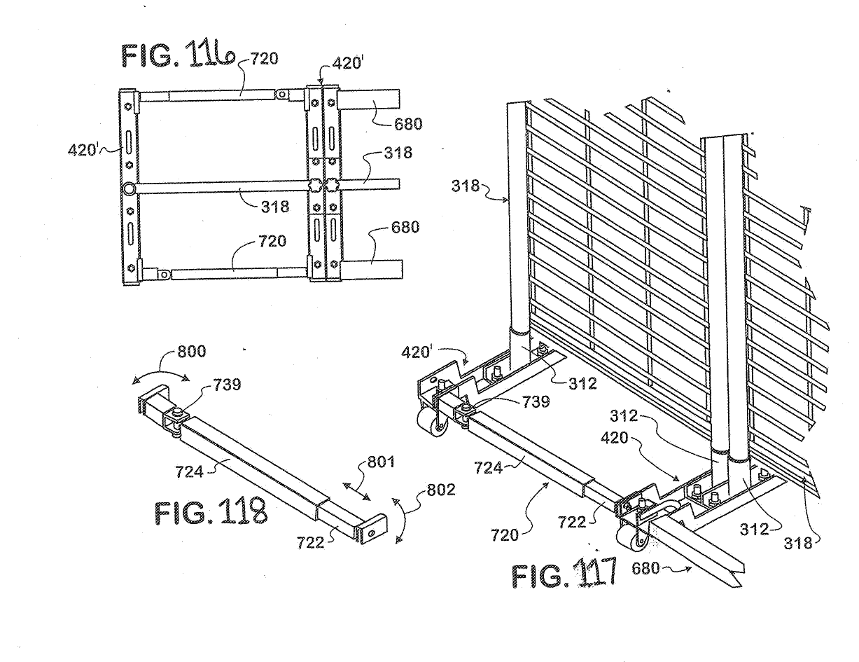

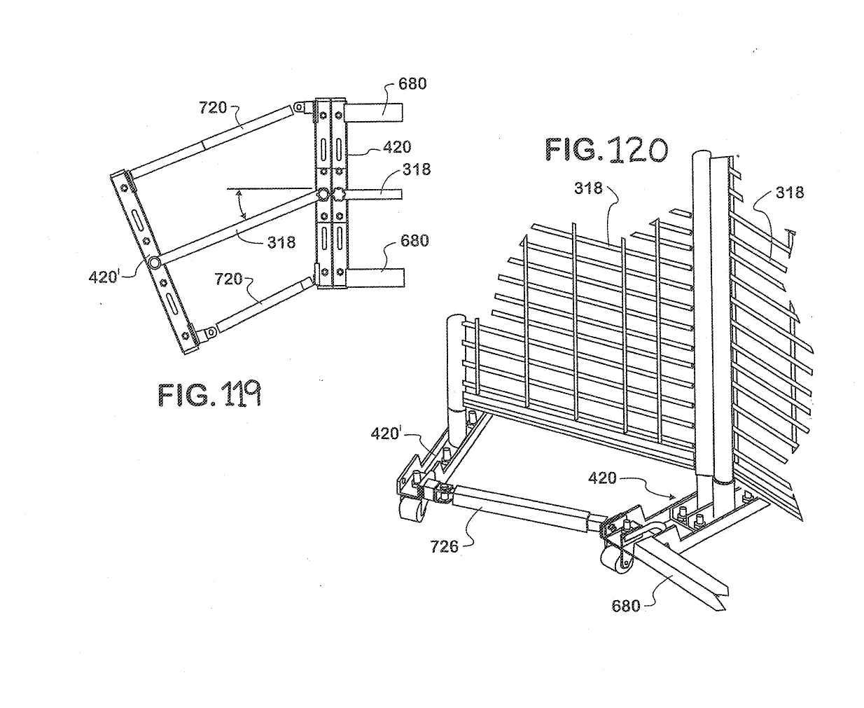

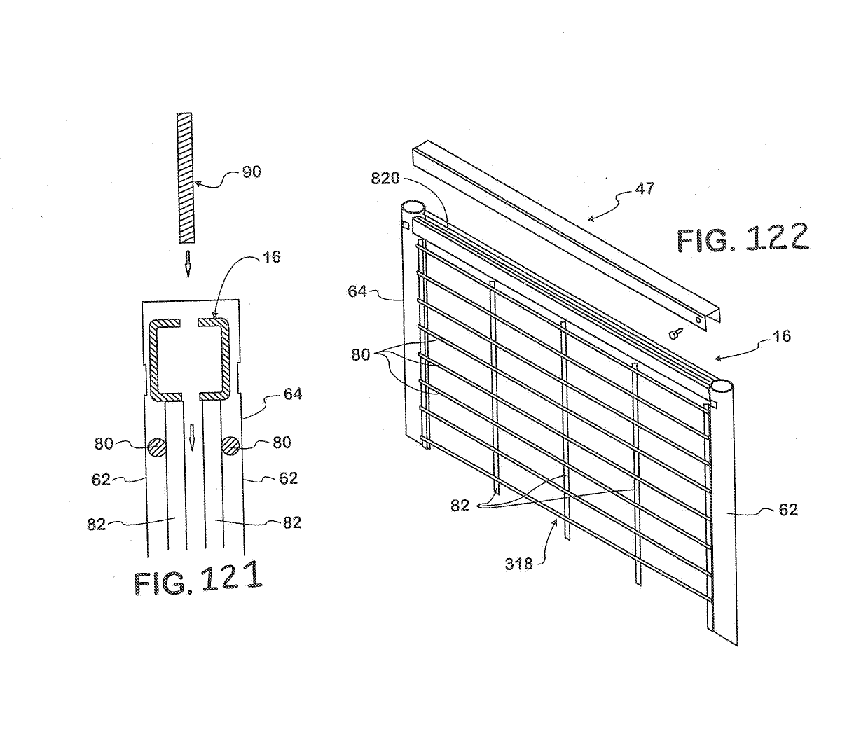

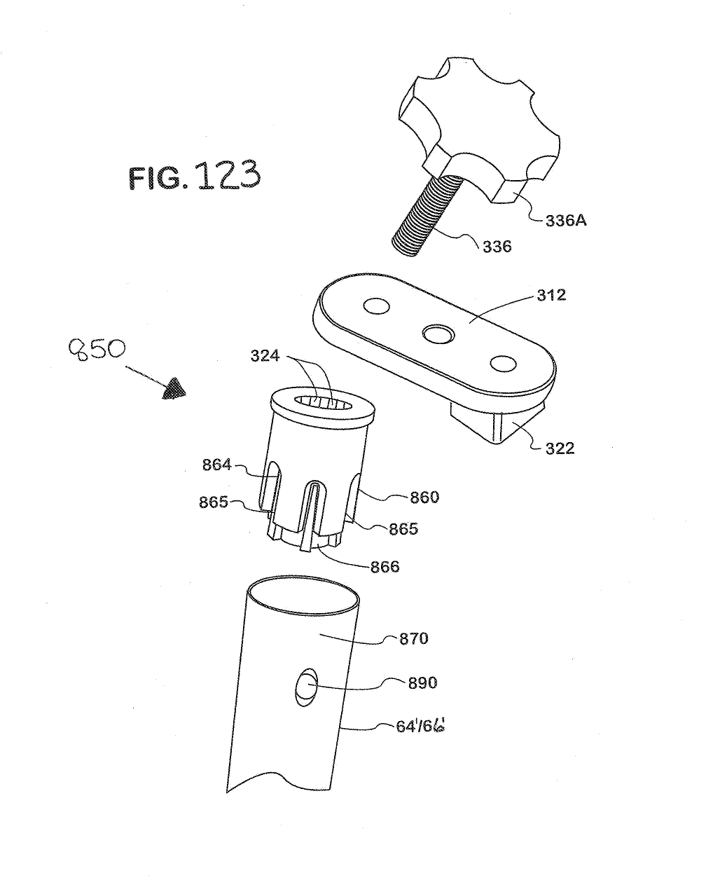

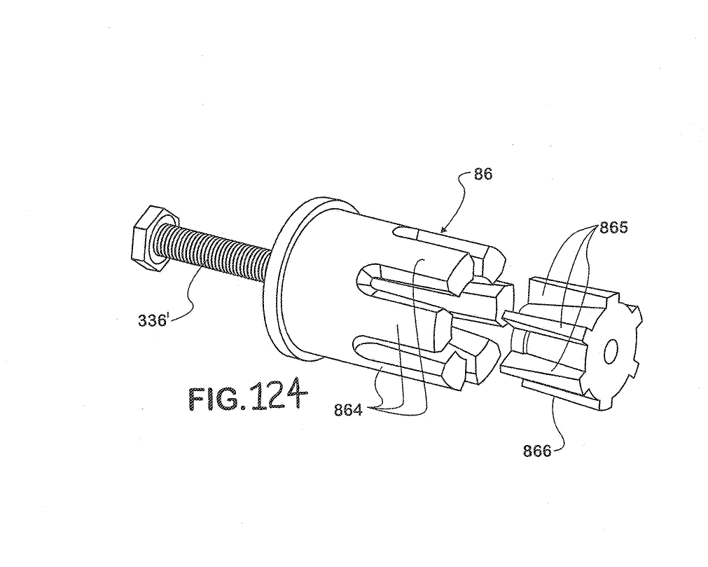

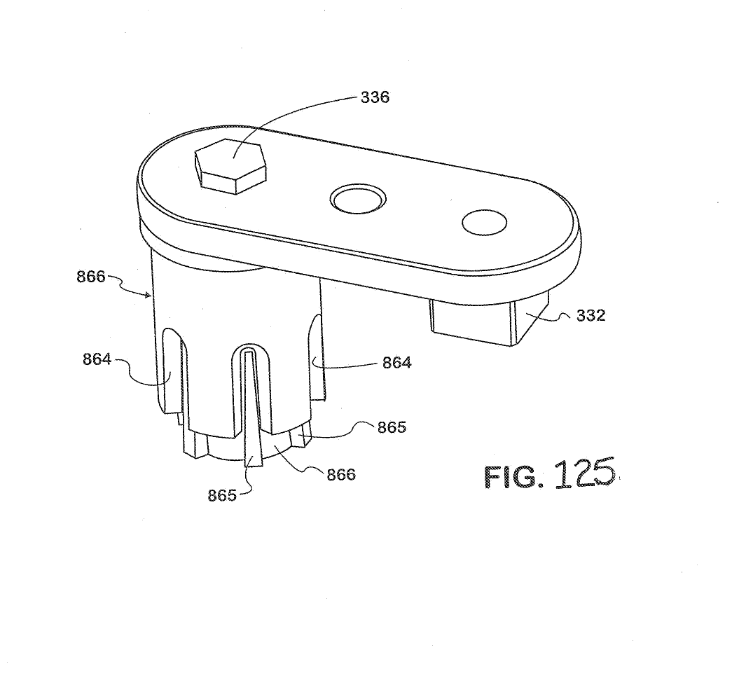

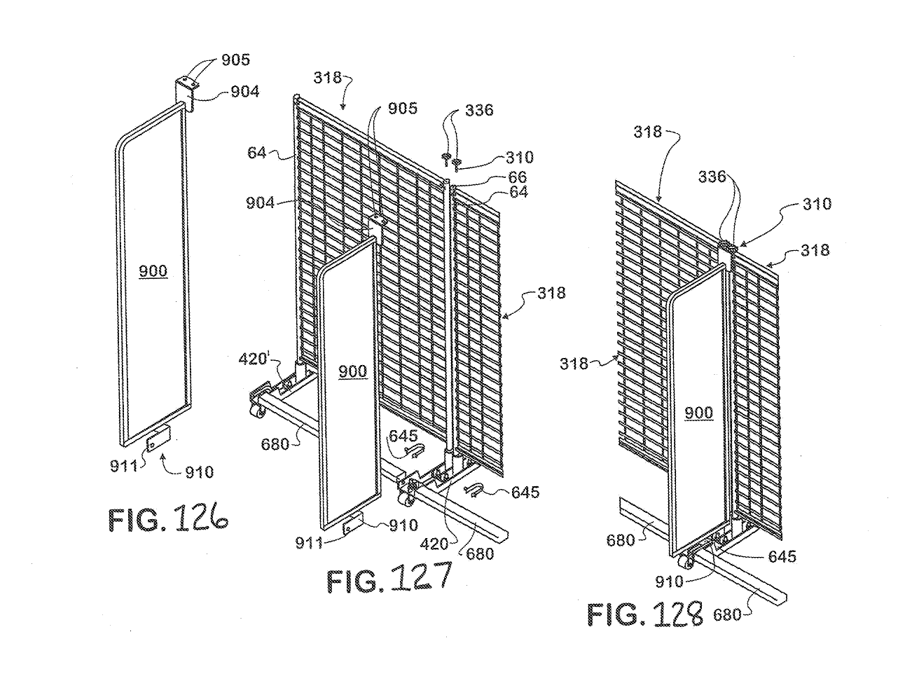

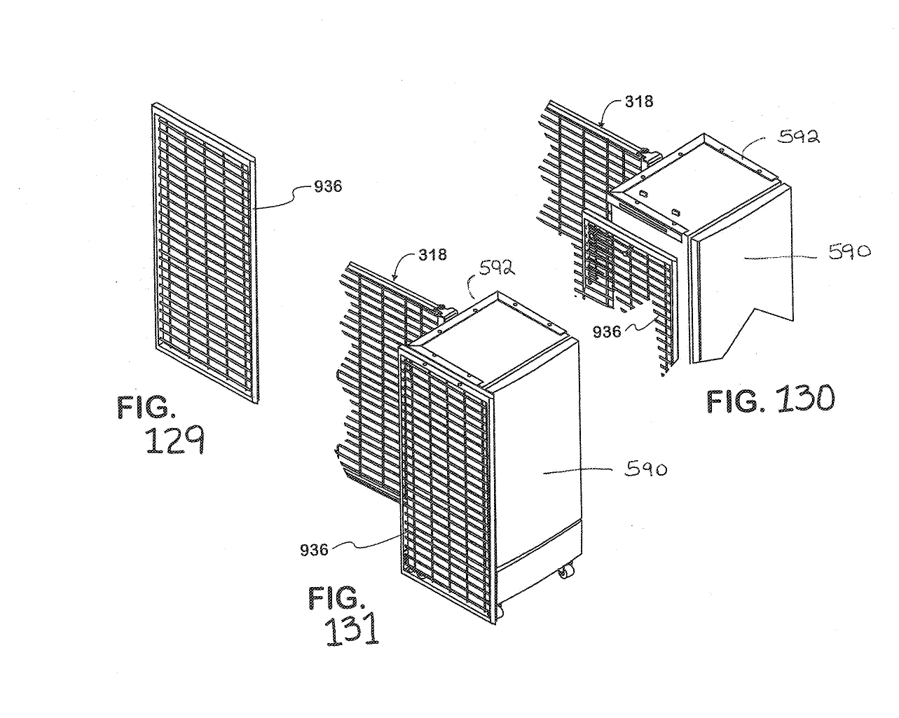

FIG. 97A to C shows the installation of a grill structure 936 onto and around a cooler 590. The grill structure 936 can be provided around most or a good portion of the cooler. As shown the grill structure 936 is fastened with fasteners to the top ring assembly 592. FIG. 97A shows the grill structure. Its installation started is in FIG. 97B and completed in 97C. The grill structure can be used as an alternative to a cooler surround and offers additional opportunity to offer additional products to the consumer and increases the retailers per square foot sales.

While several embodiments of merchandisers or front end merchandisers with various panels, including peg board and grids, hinges or couplers, and accessories for the same and business methods have been described, it should be understood, that equivalent elements and equivalent steps fall within the scope of the below presented claims.

What is claimed is:

1. A modular merchandiser system comprises at least two merchandisers each having a pair of spaced apart vertical posts, and spaced apart upper and lower members forming a frame, at least one grid panel carried on said frame, an individual, movable leg carrying each of said vertical posts, an indicia panel adjacent said grid, said grid being adapted to carry a product display accessory for said grids, said at least two merchandisers can stand singularly on its two legs or be joined at one of multiple relative angles to each other and held on its legs at said one of multiple relative angles.

2. A modular merchandiser system as in claim 1, wherein the grid comprises horizontal wires spaced several inches apart and vertical wires spaced one half foot or more apart, said grid being supported above the ground by said pair of vertical posts.

3. A modular merchandiser system as in claim 1, further including a product display accessory that hangs from said grid, said accessory having at least one hook for doing so and a second hook for hanging product there from.

4. A modular merchandiser system as in claim 1, further having connecting means to engage two or more of said merchandisers and frames or grids.

5. A modular merchandiser system as in claim 4, wherein said connecting means is movable to hold the merchandisers having grids in relative angles to linear to each other.

6. A modular merchandiser system as in claim 2, further comprising a grid hanging bracket, said vertical posts having a plurality of spaced vertical openings engaged by said grid hanging brackets, a plurality of grid hanging brackets attaching each grid to said vertical posts, each of said grid hanging brackets having a plurality of hooks to engage said grid.

7. A modular merchandiser system as in claim 1, wherein at least two of said grids are provided one on each side to form the merchandiser.

8. A modular merchandiser system as in claim 7, wherein said two grids are spaced apart and the formed spaced between can receive said indicia panel.

9. A modular merchandiser system as in claim 1, wherein said grid is welded to said frame.

10. A modular merchandiser system as in claim 7, wherein said grids are welded to said frame.

11. A modular merchandiser system as in claim 1, wherein said frame carries one or more grid panels.

12. A modular merchandiser system as in claim 1, carrying one or more of: video means, lighting means, sound means, and low voltage supply means.

13. A modular merchandiser system as in claim 1, wherein said indicia provides rows and columns for placement of displays.

14. A modular merchandiser system as in claim 1, wherein said indicia provides product display outlines and specifications.

15. A modular merchandiser system as in claim 1, wherein said frame is mounted on said two legs, and each of said leg has two caster wheels thereon one at each end of the leg.

16. A modular merchandiser system as in claim 15, wherein said frame has a post which is pivotably mounted on a leg.

17. A modular merchandiser system as in claim 16, wherein said leg carries a single post.

18. A modular merchandiser system as in claim 16, wherein said frame has two posts, one at each end, and two legs each independently pivotably mounting a post.

19. A modular merchandiser system as in claim 18, wherein there are two adjacent frames, and adjacent posts of said two frames are mounted on the same leg.

20. A modular merchandiser system as in claim 17, wherein said post is also relatively slidably mounted on said leg to vary the position of the post on the leg.

21. A modular merchandiser system as in claim 19, wherein said frames each has adjacent posts and said posts are mounted on the same leg.

22. A modular merchandiser system as in claim 21, wherein said posts are adjustably mounted on said leg to vary the positions of said posts on said leg.

23. A modular merchandiser system as in claim 22, wherein each of said posts is separately adjustably mounted on said leg so that the two legs may have different positions along said leg.

24. A modular merchandiser system as in claim 16, wherein said post is fastened to said leg.

25. A modular merchandiser system as in claim 16, wherein said post is tubular, and said leg has a lower tube interfitting with said post to hold the same.

26. A modular merchandiser system as in claim 4, wherein there are two frames and one of said frames is connected at one of its ends to the other frame between the latter's ends.

27. A modular merchandiser system as in claim 4, wherein said two frames are connected to be one of linear or at an angular to each other.

28. A modular merchandiser system as in claim 15, wherein said legs have said caster wheels.

29. A modular merchandiser system as in claim 15, wherein at least a portion of said legs can be covered by a dust cover.

30. A modular merchandiser system as in claim 15, wherein said legs are connected by a bumper rail.

31. A modular merchandiser system as in claim 1, wherein said grid is offset to form a shelf.

32. A modular merchandiser system as in claim 1, wherein an extension can be mounted above said grid.

33. A modular merchandiser system as in claim 1, wherein a cooler is mounted to said grid.

34. A modular merchandiser system as in claim 33, further comprising a top ring to attach said cooler to a top of said grid.

35. A modular merchandiser system as in claim 34, wherein said grid is mounted to one of a side and back of said cooler.

36. A modular merchandiser system as in claim 1, further comprising a surround providing three sides and made in a similar manner as said grid, said surround being connected to said grid, and said surround being adapted to receive a cooler.

37. A modular merchandiser system as in claim 30, wherein said bumper rail is held to said leg with a double headed snap button.

38. A modular merchandiser system as in claim 30, wherein said bumper rail is adjustable in length to permit angular adjustment of said leg.

39. A modular merchandiser system as in claim 30, wherein said bumper rail has at least one pivotable connection.

40. A modular merchandiser system as in claim 39, wherein said bumper rail has a pivotable connection at each of its two ends.

41. A modular merchandiser system as in claim 1, wherein said frame is connectable to a second frame.

42. A modular merchandiser system as in claim 38, wherein said bumper rail is made of telescopic tubing and has locking means to hold said telescoping tubing at relative different lengths to permit use with said leg at various angles.

43. A modular merchandiser system as in claim 2, further including a product display accessory that hangs from said grid, said accessory having at least one hook for doing so and a second hook for hanging product there from, further having connecting means to engage two or more of said frames or grids, said connecting means being movable to hold the grids in relative position angular or linear to each other, said grid being welded to said frame.

44. A modular merchandiser system as in claim 3, wherein at least two of said grids are provided on said frame one on each side to form the merchandiser, said two grids are spaced apart and space a formed there between can receive said indicia panel.

45. A modular merchandiser system as in claim 44, wherein said indicia provides rows and columns for placement of displays.

46. A modular merchandiser system as in claim 43, wherein said indicia provides product display outlines and specifications.

47. A modular merchandiser system as in claim 43, wherein said frame is mounted on legs and each of said legs at its two ends carries at least one wheel.

48. A modular merchandiser system as in claim 16, wherein said leg carries a single tube, said frame has two posts, one at each end, and two legs, each mounting a post, said posts are adjustably mounted on said legs to vary the positions of said posts on said legs, said post is tubular, and said leg has a lower tube interfitting with said post to hold the same.

49. A modular merchandiser system as in claim 43, wherein said grid is offset to form a shelf.

50. A modular merchandiser system as in claim 43, wherein an extension can be mounted above said grid.

51. A modular merchandiser system as in claim 43, wherein a cooler is mounted to said grid, wherein said panel is mounted to one of a side and back of said cooler.

52. A modular merchandiser system as in claim 43, further comprising a surround providing three sides and made in a similar manner as said grid, said surround being connected to said grid, and said surround being adapted to receive a cooler.

53. A modular merchandiser system as in claim 43, wherein said bumper rail is held to said leg with a double headed snap button.

54. A modular merchandiser system as in claim 43, wherein said bumper rail is adjustable in length.

55. A hinge coupler for connecting a pair of panels to each other, said panels each having at least a generally vertical tube adjacent each other, comprising a coupler for connecting the two panels at an angle to each other, said angle being greater than zero degrees and less than 360 degrees, said tubes having one of cooperating female sockets and male projections thereon, said coupler having two of the other of said male projections and female sockets thereon, and means for retaining said coupler in said tubes so said male projections engage in said female sockets.

56. A hinge coupler as in claim 55, wherein each of said male projections and female sockets have points.

57. A hinge coupler as in claim 56, wherein said male projection points are fewer than said female socket points.

58. A hinge coupler as in claim 56, wherein said male projection points are equally angularly spaced.

59. A hinge coupler as in claim 56, wherein said socket points are equally angularly spaced.

60. A hinge coupler as in claim 56, wherein said socket is formed in said tube.

61. A hinge coupler as in claim 56, wherein said socket is an insert and said insert is retained in said tube.

62. A hinge coupler as in claim 56, wherein said socket insert is retained in said tube by one of interference fit, adhesive, glue, brazing, welding, bonding, threading, friction, wedging and fastening.

63. A hinge coupler as in claim 61, further comprising a cross pin, and said socket is in the form of an insert, said cross pin retaining said socket insert in said tube.

64. A hinge coupler as in claim 63, wherein said insert and tube have aligned openings, said cross pin fitting into said aligned openings.

65. A hinge coupler as in claim 60, wherein said cross pin has a threaded opening, and the hinge coupler further comprising a fastener, said fastener passing through said coupler into said tube and socket insert therein and engaging in said threaded opening to hold said cross pin in place in said socket and tube, said projections and sockets and coupler together, and holding said panels at a selected angle determined by the engagement of said two projections in said two sockets.

66. A hinge coupler as in claim 55, wherein said tube is one of round, square and rectangular cross section.

67. A hinge coupler as in claim 56, wherein said male projections and said socket female points are complimentary shaped with the socket female points receiving said male points.

68. A hinge coupler as in claim 55, wherein said means for retaining includes a fastener engaging said male projections and said socket has a nut, and said nut and fastener when tightened, said nut wedges said socket in said tube.

69. A hinge coupler as in claim 68, wherein said socket has means to prevent rotation of said socket in said tube and means to prevent rotation of said nut in said socket.

70. A hinge coupler as in claim 69, wherein said socket has an indent opening, and said tube is indented, and said indent opening in said socket receives said indent in said tube to prevent the socket's rotation in said tube.

71. A hinge coupler as in claim 70, wherein said socket has one of a nut opening or nut projection, and said nut has the other of said nut projection and nut opening, said nut opening and said nut projection cooperating to prevent rotation of said nut when it is tightened.

72. A hinge coupler as in claim 55, comprising a connecting link, said connecting link having two openings therein to receive said tubes, each of said openings of said link is placed over said tubes.

73. A hinge coupler as in claim 63, wherein said cross pin has a non-circular cross-section, and said socket and said tube have non-circular openings for receiving said non-circular cross pin.

74. A hinge coupler as in claim 55, further comprising fastener means for holding said male projection in said female sockets.

75. A hinge coupler as in claim 74, wherein said fastener has a knob permitting it to be turned and tightened or loosened manually without use of a tool.

76. A hinge couple as in claim 76, wherein said male projection has four points and said female socket has more points.

77. A hinge couple as in claim 76, having two cross pins one unthreaded and the other threaded, said unthreaded cross pin fitting into an extension with said fastener passing through said one unthreaded cross pin, and said threaded opening in said other cross pin receiving said fastener to hold said extension on said grid.

78. A method for placing two panels each having an adjacent vertical tube at selected angles, comprising the steps of: providing one of a socket and a projection on one of said tubes, providing one of a socket and a projection on the other of said tubes, providing the other of said socket and projection on one end of coupling, providing the other of said socket and projection on the other end of said coupling, retaining the projections or sockets to said tubes, fitting said projections into said sockets to arrange the panels at desired angles, securing the coupling to the tube to hold the projections and sockets in selected positions, whereby the panels are held at a desired angle.

79. A business method for a merchandiser, comprising the steps of: offering a merchandiser and optionally one or more product display accessories in a first financial transaction, and offering other product display accessories in a second financial transaction.

80. A business method as in claim 3, wherein the steps of offering is one of offering a lease or sale.

81. A business method as in claim 79, wherein the step of offering is one of offering a lease extending for more than one year.

82. A business method as in claim 79, including the step of providing planning to develop display placement for said merchandiser.

83. A business method as in claim 82, including providing software to carry out said display placement for said merchandiser.

84. A business method for a merchandiser, comprising the steps of: offering a merchandiser and optionally one or more product display accessories in a first financial transaction, and offering other merchandisers in a second financial transaction.
